(19) United States
(12) Patent Application Publication
(10) Pub. No.: US 2014/0173443 A1
(43) Pub. Date: Jun. 19, 2014

(54) FITNESS COMPUTER AND SYSTEM

(71) Applicant: Wahoo Fitness LLC, Atlanta, GA (US)

(72) Inventors: Harold M. Hawkins, III, Atlanta, GA (US); Michael A. Lyle, Gainesville, GA (US); Bradley Jaymes Collins, Atlanta, GA (US); Murray Adam Hughes, Mackenzie (AU)

(73) Assignee: Wahoo Fitness LLC, Atlanta, GA (US)

(21) Appl. No.: 14/183,773

(22) Filed: Feb. 19, 2014

Related U.S. Application Data
(63) Continuation-in-part of application No. 14/135,205, filed on Dec. 19, 2013.
Application No. 14/135,205 is a continuation of application No. 13/975,720, filed on Aug. 26, 2013.
(60) Provisional application No. 61/693,685, filed on Aug. 27, 2012.
(60) Provisional application No. 61/728,155, filed on Nov. 19, 2012.

(51) Int. Cl. G06F 3/0484

(52) U.S. Cl. CPC G06F 3/0484
USPC 715/733

(57) ABSTRACT

A fitness computer system and method are provided herein. The method includes wirelessly pairing a first computing device having a first processor and a first display with a second computing device having a second processor and a second display. A page definition file is parsed to determine static display data for a current display page index. The static display data is displayed and the current display page index is transmitted to the first computing device using an application programming interface (API). Dynamic display data associated with the current display page index is transmitted from the first computing device using the API and the dynamic display data for the current display page index is displayed.

### RELATED APPLICATIONS

This application is a continuation-in-part of U.S. application Ser. No. 14/135,205 entitled “System and Method for Controlling a Bicycle Trainer” filed Dec. 19, 2013 which is a continuation-in-part of U.S. application Ser. No. 13/975,720 filed Aug. 26, 2013 entitled “Bicycle Trainer,” which claims the benefit of priority to provisional application No. 61/693,685 filed Aug. 27, 2012 entitled “Bicycle Trainer” and provisional application No. 61/728,155 filed Nov. 19, 2012 all of which are hereby incorporated by reference.

### TECHNICAL FIELD

Aspects of the present disclosure involve a fitness computer and system including a first computing device and a second computing device that communicate with one another using an application programming interface (API). The second computing device is a programmable and customizable display device for displaying data received from the first computing device.

### BACKGROUND

Smartphone and tablet usage and popularity has soared in recent years. Users of smartphones and tablets have access to a portable device that is capable of communicating with others, capable of executing applications, and capable of sending and receiving information to other devices. Smartphones are owned by more than half of American adults and may be carried in a pocket or purse. In addition, smartphones may be more powerful and easier to use than many desktop computers. Thus, smartphone users have ubiquitous access to a relatively powerful and intuitive computing device which may be held in the palm of a hand.

When purchased, smartphones may come with a number of applications (or “apps”) installed. In addition, hundreds of thousands of applications are also available for download and installation from an application store, among other sources. The applications are produced by large companies as well as individual developers. These downloadable applications are available for free or a low price and extend the abilities of the smartphone. For example, a smartphone can be used to play music by executing a music application, obtain weather information by executing a weather application, obtain news by executing a news application, play a game by executing a game application, provide turn-by-turn navigation by executing a GPS application, and record a run or a ride on a map by executing a fitness application. New applications are being released by developers on a daily basis for download. Accordingly, smartphones may be used in entirely different and new ways by downloading and executing the ever-growing library of available applications. In addition, smartphones are even more useful because many of these downloadable applications are also capable of communicating and interfacing with other hardware devices such as portable speakers, heart rate monitors, glucose meters, wireless scales, and fitness devices.

Many bicycle riders use a smartphone or small tablet and carry such devices with them during a bicycle ride in a pocket or in a backpack, seat bag, saddle bag, etc. The smartphone or tablet may also be mounted to the handlebars of the bicycle as a display device. However, the smartphone may be too large to be mounted to the bicycle and could obstruct the view of a rider, may be distracting for a rider, have a power-hungry display which quickly drains a battery, may be difficult to view outdoors in direct sunlight, and may be prone to being damaged if the rider of the bicycle were to have an accident. Many smartphones are purchased using contract subsidies and are expensive to replace if damaged and/or broken.

With these thoughts in mind among others, aspects of the fitness computer and system disclosed herein were conceived.

### BRIEF DESCRIPTION OF THE DRAWINGS

Example embodiments are illustrated in referenced figures of the drawings. It is intended that the embodiments and figures disclosed herein are to be considered illustrative rather than limiting.

FIGS. 1A-1C illustrate block diagrams of components in a fitness computer system according to an example embodiment;

FIG. 2 illustrates a block diagram showing wireless communication between the components of the fitness computer system according to an example embodiment;

FIGS. 3A-3I illustrate example screenshots of user interfaces for customizing display pages and button functions for the fitness computer system according to an example embodiment;

FIG. 4 illustrates a flowchart of a process for displaying ride information according to an example embodiment;

FIG. 5 illustrates a flowchart of a process of a hardware button push according to an example embodiment;

FIG. 6 illustrates a flowchart of a process for designing a display page according to an example embodiment;

FIG. 7 illustrates a flowchart of a process for designing button functions according to an example embodiment.

FIGS. 8A-8J illustrate example screenshots of a display of the fitness computer system according to an example embodiment;

FIG. 9 is a block diagram illustrating an example computing device for use with the example embodiments.

### DETAILED DESCRIPTION

Aspects of the present disclosure involve a fitness computer and system that provides several advantages over conventional designs. The fitness computer system includes a first computing device, such as a smartphone or tablet, which wirelessly communicates with a second computing device which acts as a “dumb” or “thin” terminal primarily comprising a liquid crystal display with physical input buttons which may be mounted to handlebars of a bicycle, mounted to a strap and worn like a watch, or mounted on any other device. The bicycle may be an actual bicycle, a bicycle trainer system or the like. A bicycle trainer which is compatible with the fitness computer and system is described in U.S. application Ser. No. 13/975,720 entitled “Bicycle Trainer,” which is hereby incorporated by reference herein. Such trainers allow riders to mount their actual bicycle to the trainer and ride the bicycle indoors.

The first computing device (e.g. a smartphone) may transmit a page definition file and dynamic data to the second display device using an application programming interface (API). The second computing device may display static data and the dynamic data for a particular display page in an array of display pages. The display pages and functionality of hardware buttons on the second computing device are customizable using a software application executed on the first computing device.

According to an example embodiment, the first computing device may connect with the second computing device using the API within an app. The API, also known as a framework, provides a bridge between the first computing device and the second computing device and allows a user to configure the second computing device using the first computing device and send data from the second computing device to the first computing device and vice versa.

The framework is bundled within the app and loaded into memory as needed by the smartphone or tablet. The framework may include shared resources such as a dynamic shared library, interface files, image files, header files, and reference documentation all within a single package. The API is made publically available for download to software developers to use to develop apps to drive what is displayed and controlled by the second computing device. As an example, software developers may add the framework to a third party app which provides a user interface for interacting with the second computing device, and upload the app to a repository of apps to be downloaded by smartphone users. The app may be executed by a user's smartphone and communicate with the second computing device using a short range wireless network. As an example, the app may be used to select and control what is displayed on the second computing device. As a further example, the app may be used to keep track of user information such as heart rate, current speed, average speed, top speed, distance traveled, heading, calories burned, etc. and communicate this information so that it may be displayed on the second computing device. In addition, the second computing device may be used to control the first computing device. Accordingly, the framework will allow the second computing device to interface with a variety of different first-party and third-party apps executed on the first computing device. For example, the framework allows the second computing device to control and interact with bicycle training apps, bicycle ride tracking apps, map apps, multiplayer synchronous game-type apps, asynchronous game apps, course leaderboard apps, course simulation apps, GPS-type apps, and music apps and players, among others.

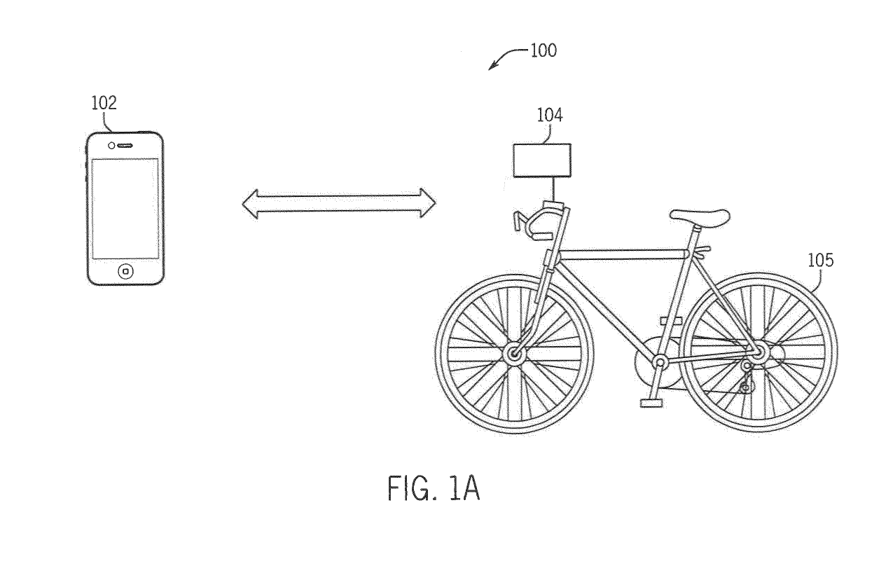

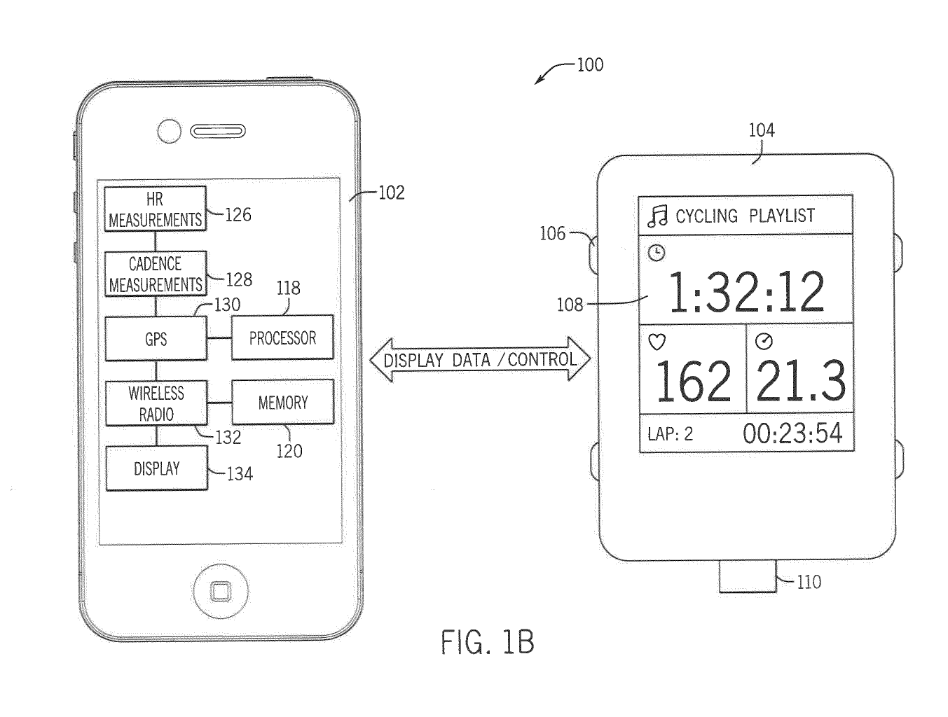

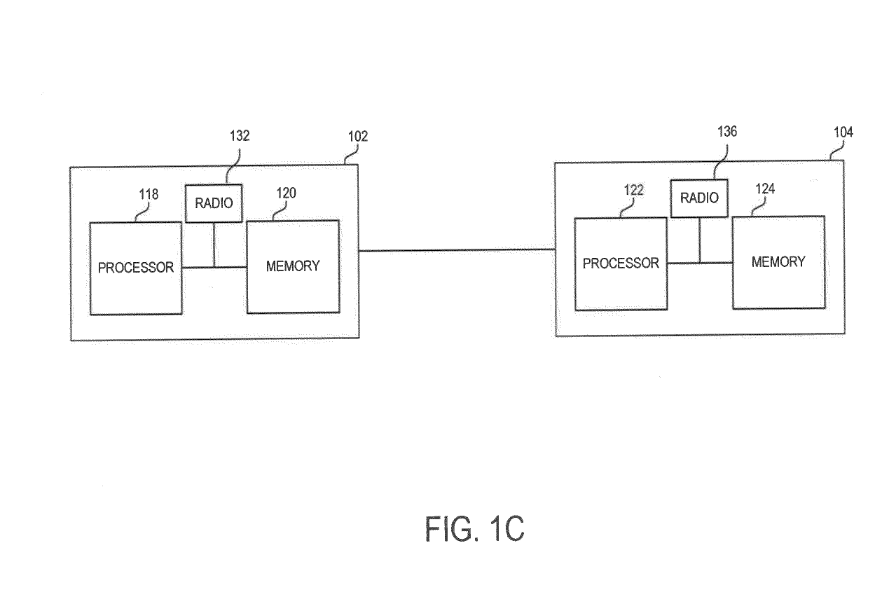

According to an example embodiment, FIG. 1A shows a block diagram of components of a fitness computer system 100. The fitness computer system 100 may include a first computing device 102 and a second computing device 104 which may be mounted to a bicycle 105. As described below, the first computing device 102 and the second computing device 104 may communicate using a short range wireless network. As an example, the short range wireless network may operate using the 2.4 GHz frequency and may have a range of approximately ten meters. According to an example embodiment, the first computing device 102 and the second computing device 104 may communicate using Bluetooth™ or the ANT+™ protocols using wireless radios, as described herein.

FIGS. 1B and 10 illustrate additional details of the components of the bicycle computer system 100. The first computing device 102 includes a processor 118 and a memory 120 and may be any of a laptop, a smartphone, a tablet, a personal digital assistant, a portable music player having a display, a watch, or other such devices. The first computing device 102 may include or may be connected to a heart rate monitor to receive heart rate measurements 126, a cadence monitor to receive cadence measurements 128, a GPS receiver 130, a wireless radio 132, and a display 134. According to one specific embodiment, the first computing device 102 is a smartphone. As shown in FIG. 10, the second computing device 104 may also include a processor 122 a memory 124, and a wireless radio 136. According to an example embodiment, the second computing device 104 may be mounted on the bicycle 105 and used as a remote display and control for an app executing on the first computing device 102. The second computing device 104 may also be connected to a strap and worn as a watch, connected to a go-kart, motorcycle, kayak, etc. Due to the nature of the system 100, opportunities may be developed for any number of activities with control and display achieved through the second computing device 104. With reference to the bicycle use, the second computing device 104 may include a plurality of hardware buttons 106, a display 108, and a mounting device 110 for mounting the second computing device 104 to the handlebars or the stem of the bicycle 105 for easy viewing and accessibility for a rider.

As an example, the second computing device 104 may include four hardware buttons 106 as shown in FIG. 1B: one at the top right corner, one at the top left corner, one at the bottom left corner, and one at the bottom right corner. However, the second computing device 104 is not limited to having four hardware buttons, and may include more or less than four hardware buttons. The second computing device 104 could also include a touchscreen and be controlled via touch through the screen, or other forms of user inputs. The hardware buttons 106 may be aluminum, plastic, etc. and provide a rider with easy access to control what information is displayed on the second computing device 104 and functions of the first computing device 102. Typically, when you ride, your smartphone is not accessible, and may be tucked away in a bag or a pocket. As a result, it is difficult to view the screen of the smartphone or operate any application that may be running on the smartphone. For example, it may be difficult to change music tracks, check the time, check a map, control a fitness app, and check battery life. The second computing device 104 allows a user to view information sent via the API from an app running on the first computing device 102 and safely control the first computing device 102 via the API while riding.

According to an example embodiment, the second computing device 104 may also include an altimeter (not shown) which determines an altitude based on air pressure. Although the first computing device 102 may include GPS/GLONASS hardware which may be used to determine an altitude, GPS based receivers are sometimes unable to determine an accurate altitude because of the limitations of non-barometric altitude calculation. Moreover, there may be instances when the first computing device is unable to obtain a GPS signal such as when riding in a wooded area. Thus, the second computing device 104 may include an altimeter which may provide accurate altitude information for display during a bicycle ride. Similarly, the first computing device 102 may include an altimeter, and the second computing device 104 is configured to display an altitude calculated by the altimeter.

The second computing device 104 may be powered by a power source such as a replaceable coin cell battery (not shown). According to an example embodiment, this coin cell battery may be a user changeable CR2450 battery which may last approximately eighteen months of use. Thus, unlike a smartphone having a limited battery life, the second computing device 104 may include a battery that is suited for extended use. Moreover, given the lightweight nature of the processor 122 and display 124, among other components, the second computing device 104 simply uses less energy than a conventional smartphone.

According to an example embodiment, the display 108 may be a 128×128 pixel chip-on glass (COG) liquid crystal display (LCD). However, the display 108 is not limited to a COG LCD and is also not limited to a 128×128 pixel display. The display 108 may be driven by a LCD driver having a frame buffer including two or more pages. The information in each of the pages of the frame buffer may be derived from a data structure such as a 128×128 bitmap wherein each bit in the bitmap stores or represents a value of either “0” or “1” for each of the pixels on the display 108. A value of “0” for one of the bits of the bitmap may indicate that a corresponding pixel is “off” or not illuminated and a value of “1” for one of the bits of the bitmap may indicate that the corresponding pixel is “on” and illuminated.

The display driver cycles through each of the pages in the frame buffer and then sequentially displays the pages. The LCD display is able to draw into one of the pages in the frame buffer while displaying another page in the frame buffer. Stated differently, the LCD display displays the information for a first page in the page buffer while populating the data to display a second page in the page buffer. Once drawing one of the pages is done, the LCD display flips to the newly drawn page, and the previously displayed page is available to be updated. So, for example, if the display is configured to receive elevation data and speed data from an app on the first computing device 102, the first frame buffer page may be displaying elevation and speed data, while the second frame buffer page is receiving the most current data from the app. The most current data in the second frame buffer page is then displayed, and new most current data is used to populate the first frame buffer page, and so on.

In one specific implementation, the display 108 is a monochrome display. Further, the display 108 may include a backlight (not shown) for early morning and evening use and may be waterproof. Additionally, the display 108 may have an option to invert grey scale on the screen which may be helpful in certain lighting conditions.

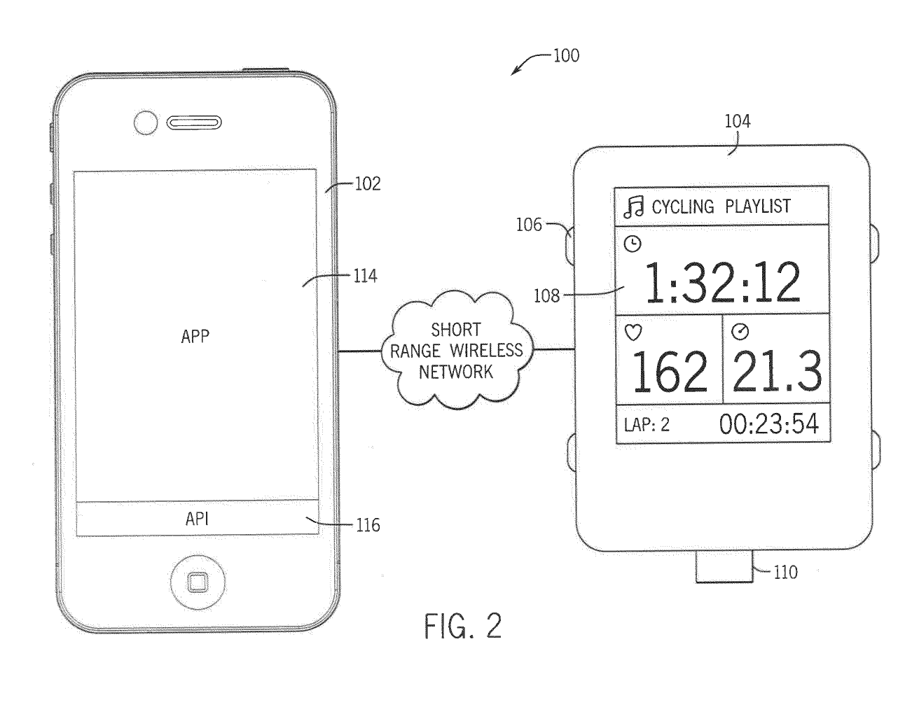

FIG. 2 illustrates a block diagram showing wireless communication between the components of the fitness computer system 100 according to an example embodiment. As shown in FIG. 2, the first computing device 102 and the second computing device 104 may communicate with one another via wireless radio 132 and wireless radio 136 using a short range wireless network 112 operating on a wireless protocol such as Bluetooth™ and/or Area Network Technology (ANT+)™, etc. The communication between the first computing device 102 and the second computing device 104 is provided by an API 116 known as a framework which is bundled within an app 114 installed on the first computing device.

Typically, a display of the first computing device 102 may consume a great deal of battery power while on. The first computing device 102 may communicate with the second computing device 104 without requiring the first computing device 102 to have its display active by running the app 114. Thus, according to an example embodiment, the first computing device 102 may transmit data to the second computing device 104 wirelessly while using minimal battery power. In other words, the second computing device 104 may act as a mirror, and receive and display information collected and generated by the app 114 on the first computing device 102. Additionally, according to an example embodiment, the second computing device 104 need not connect to additional hardware sensors as this is done by the first computing device 102. The first computing device 102 may connect to additional hardware sensors shown in FIG. 1B such as a heart rate monitor to receive heart rate measurements 126, a cadence monitor to receive cadence measurements 128, etc., and wirelessly transmit data received from the additional hardware sensors to the second computing device 104 for display. In short, the second computing device 104 is “driven” by the first computing device 102 and the first computing device 102 may receive data from other sources.

According to an example embodiment, the API 116 provides a bridge or interface between the app 114 executing on the first computing device 102 and the second computing device 104. The API 116 is distributed as the framework, which provides a convenient means of packaging headers and binaries into a single logical unit. As the framework is static, libraries may be linked into an application build. The framework need not be installed on the second computing device 104, but rather is linked and compiled into a final application binary on the first computing device 102. The API 116 allows any number of different apps to communicate with and receive information from the first computing device 102 in a common form. Hence, a user may cause different apps on a smartphone to commonly interact with the same second computing device 104.

According to an example embodiment, the API 116 or framework may be downloaded from a publicly available website. After downloading the API 116 from the website, an application developer can import the framework into an application by using an integrated development environment (IDE) such as Xcode™. Xcode includes a plurality of software development tools which have been developed by Apple™ for developing software for the Mac™ and iOS™ devices. The API 116 is not limited for use with Mac™ and iOS™ devices. As an example, the API 116 may provide an interface between computers, iOS™ devices, Android™ devices, Windows™ devices, and other similar computing devices. Furthermore, the IDE is not limited to Xcode™ and can include other IDEs such as Eclipse™, etc.

According to an example embodiment, a primary class of the API 116 is WFHardwareConnector. As an example, this class enables a developer using a computer, e.g., a Mac™, to write an app to configure what may be sent from the first computing device 102 to the second computing device 104 and displayed on the second computing device 104. The first computing device 102 and the second computing device 104 may use the API 116 to send and retrieve data and commands using ANT+™ or Bluetooth™. The framework or API 116 includes mirrored functionality and identical command sets for both Bluetooth™ and ANT+™.

ANT+™ allows a first computing device 102 to communicate with a plurality of other computing devices such as more than one second computing device 104. Accordingly, ANT+™ may be used in a gym environment. As an example, a gym may have ten bicycle trainers each having a second computing device 104 mounted to the handlebars and a gym member may pair their smartphone with a second computing device 104 that is different from a previous workout for a current workout because the bicycle trainer used during a previous workout may be occupied. In other words, the gym member is not limited to using the same second computing device 104 for each work out. In addition, a bicycle class organizer could setup a plurality of second computing devices for the class so that they provide a set of display pages/hardware button functionality for the entire class. While there are benefits of using ANT+™, ANT+™ also has drawbacks. As one example, with ANT+™ it is possible that more than one user could pair with the same second computing device 104. This could result in a problem. Thus, in certain instances, use of Bluetooth™ may be more desirable.

Bluetooth™ is a one-to-one wireless protocol. This serves as a limit, but it can also be beneficial. This means that each Bluetooth™ device, such as the second computing device 104, advertises that it is pairable with another device, such as the first computing device 102, only until it is paired. A Bluetooth™ device, such as the second computing device 104, will send radio signals requesting a response from any device with an address in a particular range. In other words, once a second computing device 104 is paired with a first computing device 102, it will be paired with that computing device and cannot be paired with another computing device until the second computing device 104 is unpaired. Bluetooth™ may be a useful protocol for a home gym experience, or for outdoor bicycle rides by a single rider because a smartphone can be paired with a specific second computing device 104 that is mounted to a bicycle or bicycle trainer.

According to an example embodiment, a user may launch and execute an app 114 on the first computing device 102 and select “Biking” as a workout type using the app 114. The app 114 may be used for additional workouts, which are unrelated to the disclosure herein. Next, the user may begin a sensor pairing process to have the first computing device 102 pair with the second computing device 104. A user may press any of the hardware buttons 106 on the second computing device 104 to have the second computing device 104 “wake up.” When not in use, the second computing device 104 continues to operate using a very low power. After a certain period of time of inactivity, e.g., no hardware button pushes or Bluetooth™ communication, the second computing device 104 will power down.

When the first computing device 102 is executing the app 114, the second computing device 104 is awake, and they are within a particular proximity of one another, the first computing device 102 and the second computing device 104 will automatically pair with one another using a wireless protocol, e.g., ANT+™ or Bluetooth™. According to an example embodiment, when pairing using Bluetooth™ or ANT+™, the range for communication will be approximately ten meters or less.

Once paired with one another, the first computing device 102 and the second computing device 104 are ready for bidirectional communication, and both the first computing device 102 and the second computing device 104 may display a visual indication as well as provide an audio indication that the pairing was successful. As an example, the app 114 may display a Bluetooth™ or an ANT+™ logo in a top corner of a user interface.

Using the wireless protocol, the first computing device 102 and the second computing device 104 may communicate with one another. According to the example of using the system 100 while riding, the user of a bicycle 105 may desire to display a particular set of information on a display of the second computing device 104 during the ride.

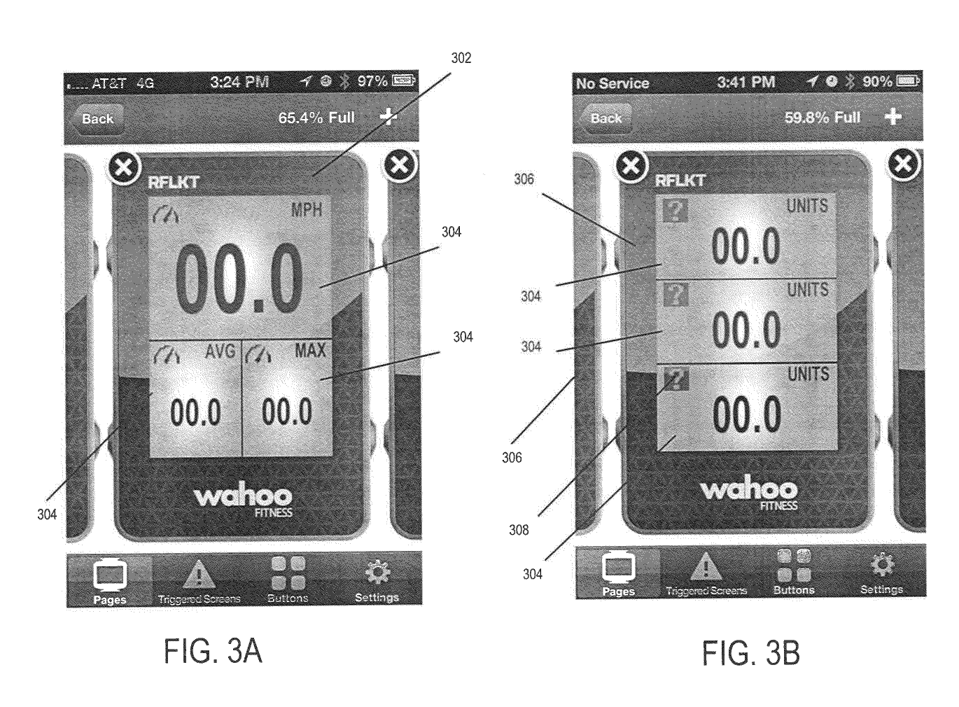

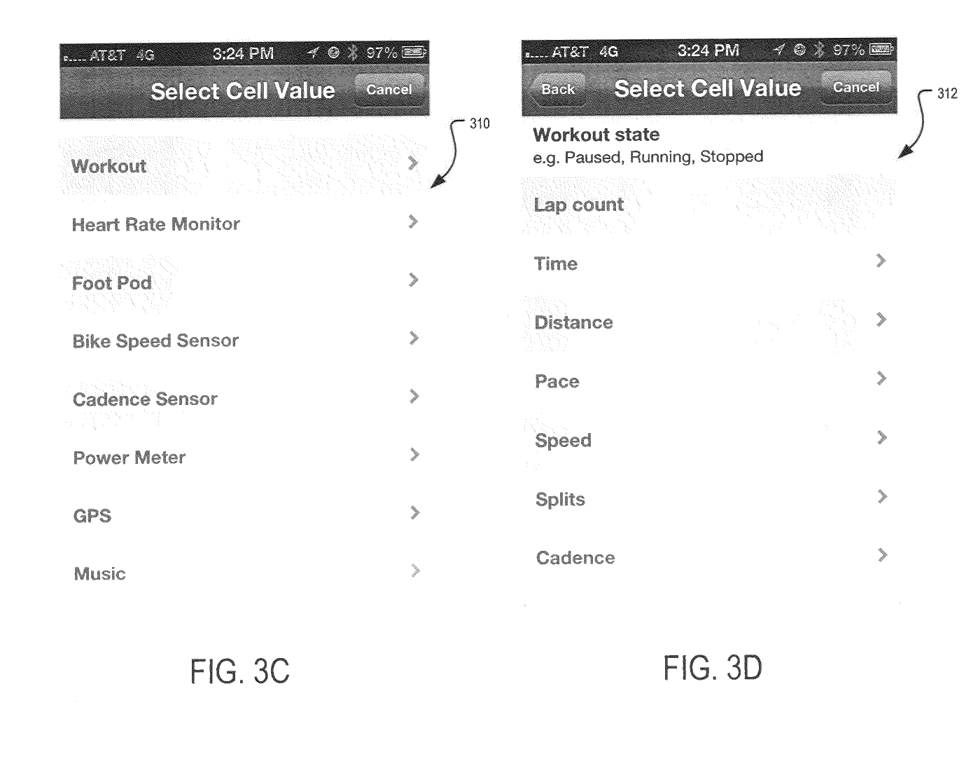

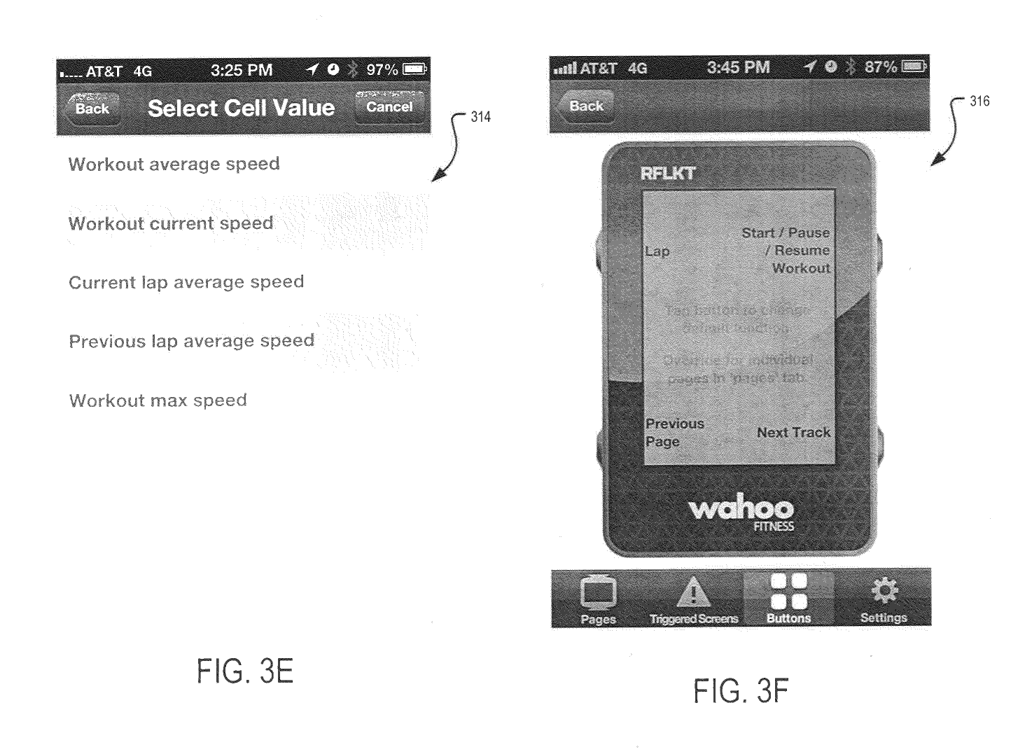

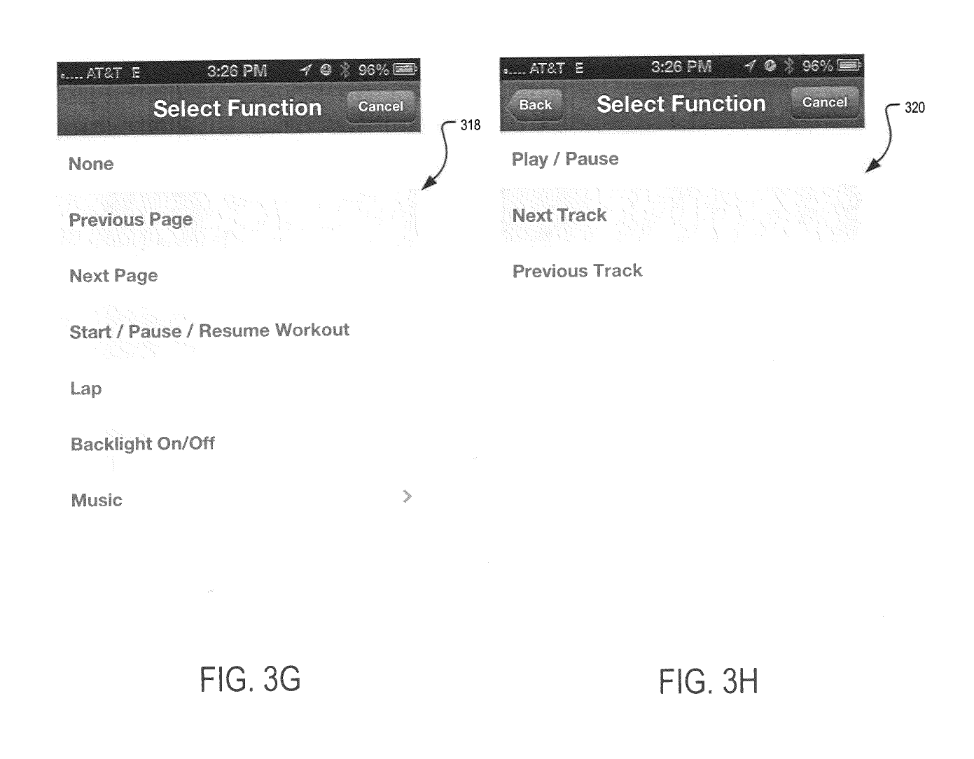

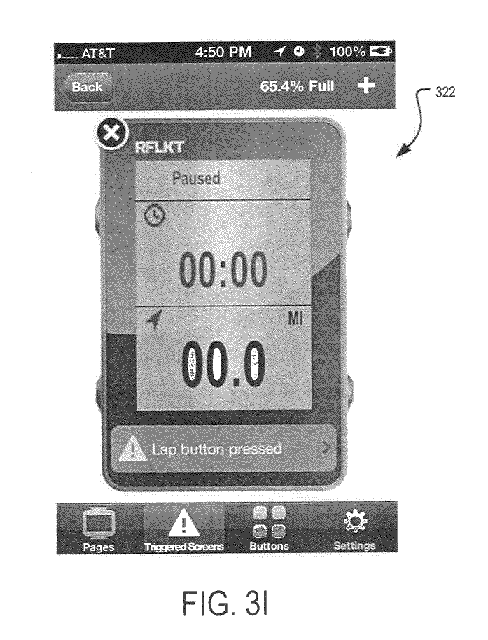

As shown in FIG. 3A, by opening a menu within the app 114 on the first computing device 102, the user can configure personalized display pages for the second computing device 104. The user can, for example, select from a variety of possible preset display pages 302 (one of which is shown in FIG. 3A) having at least one data cell 304 with specific information assigned to each cell 304. Alternatively, the user can configure a display page using display page templates, such as example page template 306 as shown in FIG. 3B having at least one data cell 304. For the example page template 306, the user can customize each cell 304 in the display page by selecting from available display options.

As an example, the user may want to display a current heart rate, a mileage, and music information on a display page. The user can configure a page with those parameters by first selecting a display page template 306. The page template 306 in FIG. 3B has three data fields to which the user can assign heart rate, miles, and music, respectively. To assign data to the cells, the user can select a cell 304 having a question mark 308 indicating that the cell has yet to be setup in the display page template and assign a data type to it. The user can continue to select each data cell 304 in the display page template 306 and assign a data type to it. In operation, the user touches the screen within the cell 304 to which the user will assign a data type. The app 114 may then take the user to a menu with a list of different available data types or other information that can be assigned to the cell 304. FIGS. 3C and 3D illustrate various data categories that may be selected. In this example, a given data category will display a second menu with specific data or information for a data value. For example, if the user selects “speed” then a menu may be provided where the user can select speed as current speed, average speed, maximum speed, miles per hour or kilometers per hour (for the various alternative speed displays), and also the sources of speed calculation (cadence sensor or GPS, for example).

As shown specifically in FIG. 3C, the user can select from cell value categories 310 including “Workout,” Heart Rate Monitor, Foot Pod, Bike Speed Sensor, Cadence Sensor, Power Meter, GPS, and Music. Next, the user can select a cell value for the category chosen. As an example, if the user selects “Workout,” then as shown in FIG. 3D, the user can then select from the following options 312 for the cell value: Workout state, Lap count, Time, Distance, Pace, Speed, Splits, Cadence, and Calories. Some of these options have sub-options. Time includes current lap running time, current lap total time, previous lap time, workout active time, and workout total time. Distance includes workout distance, previous lap distance, and current lap distance. Pace includes workout average pace, previous lap average pace, current lap average pace, workout max pace, workout min pace, and workout current pace. Speed includes workout average speed, workout current speed, current lap average speed, previous lap average speed, and workout max speed. Splits includes fastest mile/kilometer and last mile/kilometer. Cadence includes a general current cadence value, workout average cadence, current lap average cadence, previous lap average cadence, workout max cadence, and workout min cadence. Calories includes current lap calories, workout calories, and calories burn rate.

As an example, if the user selects “Speed,” then as shown in FIG. 3E, the user can then select from the following options 314 for the cell value: Workout average speed, Workout current speed, Current lap average speed, Previous Lap average speed, and Workout max speed. If the user selects “Workout average speed,” then the selection will be assigned to the data cell and displayed in the assigned cell on the display page. The “Workout average speed” data cell 304 on the display page can be reassigned by simply selecting it, selecting a cell value category, and selecting a new cell value. Once each data cell in a display page is assigned a cell value, the display page is entered into an array of display pages. The user can also rearrange the order of the array of display pages and can delete display pages from the array. This customization of display pages is discussed further herein.

As an example, the second computing device 104 accepts page definition files from the first computing device 102 sent via the API 116 that define the location, style, data, etc. for fields and symbols used on each display page. For example, elements of a display page may exist to draw lines, circles, bitmap images, set font sizes, width, style, format, and location for textual data on a display page, such as a current speed.

In other words, a programmer of an app is not limited to the example cell values and button functionality as provided above and can configure data to be displayed in the cells and button functionality to suit a specific app. Thus, the app 114 may provide the user of the app with a nearly unlimited set of data display options for a display page and button functionality for the hardware buttons. The app programmer may utilize the API/framework in order to design display page templates based on data collected by the app 114 and provide customizable options for the user of the app. Each display page may include at least one cell having objects including static text, dynamic text, static sprites, and dynamic sprites. The static text and dynamic text may have a font name, font size and an x,y location which represents an exact position on the display 108. According to an example embodiment, the x and y values will range from 0 to 128 based on the size of the display 108. However, the x and y values simply represent a pixel position on the display 108 and are not limited to 0 to 128. The sprites will also have an associated x,y location. Dynamic sprites may include a graph such as a graph of elevation, heart rate, speed, pace, weather radar, etc.

In providing display page templates, the app programmer may select how many cells are on a display page, a size of each cell, and where to place each object within a cell. As an example, a display page template may include any number of customizable cells which may have a variety of shapes and sizes. As noted above, an example template is shown in FIG. 3B.

As shown in FIG. 3B, the display page template displayed on the first computing device 102 includes three similarly sized rectangular cells, each of which may include static text, dynamic text, and a sprite. For the first cell, the static text would display where “UNITS” is shown and dynamic text, related to the static text in this example, would display where “00.0” is shown. The display page may include other cells, similar to the first cell which are designed by the app programmer and may include static text, dynamic text, and a sprite. The display page need not have three cells, and the cells need not be a similar size or shape as shown in FIG. 3B.

An app programmer may add at least one display page template to an app for selection by a user. A user of the app may customize as many display pages as desired by using the display page templates. However, there may be a finite amount of memory available for storage of the display pages on the second computing device 104. As shown in FIG. 3B, the memory for display pages on the second computing device 104 is 59.8% full.

The layout of the cells may be preset and organized by an app programmer, who can select text sizes, sprite sizes, and borders for each of the cells on the display page template. Each display page template may be stored within an app, and chosen and customized by a user of the app during configuration of the array of display pages. Example customized display page cells which are directed toward specific app functionality are described below.

In addition to customization of display pages, according to another example embodiment, a rider can use the app 114 to customize and configure functions for each of the hardware buttons 106. According to an embodiment, as shown in FIG. 3F, the user is presented with a grid of selectable functions 316 to assign to each hardware button 106. The grid of assignable functions 316 is presented within a user interface of the app 114. To configure a hardware button 106, the user can select one of the four buttons displayed within the app 114 on the first computing device 102. After selecting one of the buttons displayed in the app 114, as shown in FIG. 3G, the app 114 presents a list of button function options 318 including None, Previous Page, Next Page, Start/Pause/Resume Workout, Lap, Backlight On/Off, and Music. If the user selects Music, the app will display a list of Music function options 320 as shown in FIG. 3H including Play/Pause, Next Track, and Previous Track. The user can select one of the button functions, and the button function will be assigned to the selected hardware button.

In one specific implementation, each hardware button 106 may be configured for a single press function as well as a double press function, although other sequences and depress times are possible. In addition, the hardware buttons may also be configured for a short press or a long press. As an example, a short press may be defined as a button press less than two seconds, and a long press may be defined as a button press longer than two seconds. In other words, each hardware button 106 may be used for more than one function.

Hardware button actions are defined on a per display page basis within page definition files that are transferred from the first computing device 102 to the second computing device 104 using the API 116. When a hardware button is pressed on the second computing device 104, this sends an indication from the second computing device 104 to the first computing device 102 via the API 116. The indication may include data such as information about the hardware button press including a button press type, e.g., a double tap, a triple tap, a long press. Some hardware button actions simply alert the first computing device 102 that the button was pressed allowing the app 114 to respond and do whatever is appropriate for that particular button action. For instance, some button actions may act on an internal state of the second computing device 104 and pass information back to the first computing device 102 using the API 116. As an example, for a next display page button press, this would change a current active display page using the page definition file(s) stored on the second computing device 104. The display page will change on the second computing device 104 and simultaneously transmit a next page action to the first computing device 102 using the API 116 so that the app 114 is aware that data corresponding to a next display page should be sent to the new active display page on the second computing device 114.

When the “display previous display page” button is pushed, the second computing device 104 will traverse the array and if there is a previous display page, display a previous display page. As an example, if there are three display pages in the array including 0, 1, and 2, and the current display page is “1,” the display page index will be changed to “0.” The second computing device 104 will parse the page definition file to determine what cells should be displayed on display page “0” and begin to display any static information. According to an exemplary embodiment, “parsing” includes determining what data is in the page definition file and determining what the second computing device 104 requires in order to display a current display page. The second computing device 104 will send the changed display page index “0” to the first computing device 102. The first computing device 102 will parse the page definition file to determine what data is to be displayed on the second computing device 104, and send dynamic display data associated with the display page as well as a previous display page and a next display page to the second computing device 104. The second computing device 104 will then display all static and dynamic information on the display page “0.”

Generally, the app 114 is transmitting data for an active display page to the second computing device 104 as well as for a next display page and a previous display page in order to avoid any visible delay when a next page or a previous page button is pressed. When a next page action is initiated by a button press, or a next page action is initiated due to a time based change, the second computing device 104 changes the current display page and sends the new current page index to the first computing device 102 using the API 116 so that the app 114 can adjust the data that is being transmitted. According to an exemplary embodiment, the app 114 calls pageForKey(currentDisplayPage) in order to send the current page index from the second computing device 104 to the first computing device 102.

When the “display next display page button” is pushed, the second computing device 104 will traverse the array of display pages and if there is a next display page, display a next display page. As an example, if there are three display pages in the array including 0, 1, and 2, and the current display page is “0,” the display page index will be changed to “1.” The second computing device 104 will parse the page definition file to determine what cells should be displayed on display page “1” and begin to display any static information. The second computing device 104 will send the changed display page index “1” to the first computing device 102. The first computing device 102 will parse the page definition file to determine what data is to be displayed on the second computing device 104 and send dynamic display data associated with the display page as well as a previous display page and a next display page to the second computing device 104. The second computing device 104 will then display all static and dynamic information on the display page “1.”

According to further embodiments, the second computing device 104 may communicate data other than a current page index to the first computing device 102. As an example, using the API 116, the second computing device 104 may communicate a current altitude to the first computing device 102 by using the altimeter in the second computing device 104. This may allow the first computing device 102 to receive more accurate altitude information than possible using GPS hardware available in the first computing device 102, and store altitude information as well as populate a user interface displayed on the display 108 of the first computing device 102 with altitude information. The second computing device 104 is not limited to communicating altitude information to the first computing device 102, and may also communicate additional information from any other hardware sensors which may be connected to the second computing device 104.

When the lap button is pushed, a current lap time will be saved to the app 114 on the second computing device 104 and a new lap begins. The second computing device 104 will send the lap time to the first computing device 102 and the first computing device 102 will persist the data either locally or in a connected storage available via a network connection. The second computing device 104 will then begin a new lap and the new lap time will be displayed on the display.

A press of the lap button or a software-based event within the app 114 may cause a trigger screen to be displayed on the second computing device 104. As shown in FIG. 3I, each time the lap button is pressed, the trigger screen 322 may be displayed on the second computing device 104. Other example trigger screens may be driven by events such as the start of a new song being played by the first computing device 102 or a change in a workout state within the app 114. The trigger screen 322 is modal, e.g., it is a child window that displays temporarily on a current display page and may appear as if it is “on top” of a current display page. As an example, the trigger screen 322 may flash on the screen of the second computing device 104 temporarily and then will not reappear until the lap button is pressed again. The data for the trigger screen 322 may be populated into a specific a page buffer and when the trigger button is pressed, the data in the page buffer may be displayed on the screen temporarily, e.g., for five seconds after it is pressed, and then the second computing device 104 will transition to display the current display page that is displayed “underneath” the trigger screen.

Thus, the lap button is generally configured to change a current page index to a new page index for a configurable period of time. As an example, the new display page may temporarily display a last lap time, a last lap speed, and a last lap number for five seconds, and then the new display page will transition back to what was being displayed before the new display page. When pressed, the lap button will also send a message to start a new lap from the second computing device 102 to the app 114 on the first computing device 102 using the API 116.

When the music button is pushed, the user is able to control music functionality within the app 114 or any audio app that may be currently executing on the first computing device 104. The framework includes functionality for controlling the play and selection of music files which are stored on the first computing device 102 as well as any app which may be used to play music or audio. Thus, the user may be able to access and control music within a library on the first computing device 102 using the second computing device 104. In addition, at the second computing device 104, the user may access and control music/audio that is being streamed or played by an app on the first computing device 102. The second computing device 104 may control an app, such as Pandora™ or a podcast app that is running on the first computing device 102. As an example, by pressing the music hardware button on the second computing device 104 the user may cause a music app to launch and begin playing on the first computing device 102. As another example, by pressing the music hardware button on the second computing device 104, the first computing device 102 may skip to a next song in the music app or Pandora™. When the music hardware button is pressed, the second computing device 104 will use the API 116 to send a message to the first computing device 102, and the app 114 will utilize a media player framework embedded in the app 114 to execute a media related function. Depending upon the developer's implementation that is completely customizable, when a new song is played by the first computing device 102, the first computing device 102 may send a new song event to the second computing device 104. According to the developer's customization of the app 114, this new song event may cause a trigger screen to be displayed for five seconds on the second computing device 104. The trigger screen may include a song title/song artist information.

### Example Display Page Cells

In one specific possible implementation, the app 114 may be a fitness app that communicates with a heart rate monitor. The heart rate monitor may be connected wirelessly to the first computing device 102 using the short range wireless network 112. The first computing device 102 collects heart rate data from the monitor and produces a heart rate value using the heart rate data. As shown in FIG. 3B, a user may select a display page template within the app 114 on the first computing device 102 and begin configuring the display page for display on the second computing device 104. One of the cells that is displayed on the second computing device 104 may be customized to include the static text “HR” representing heart rate as well as dynamic text that corresponds with the heart rate value (e.g. 142) calculated and transmitted by the app 114. The sprite may be a heart logo.

The first computing device 102 may communicate this heart rate data to the second computing device 104 using the API 116. As an example, heart rate data may be transferred as a single byte value from the first computing device 102 to the second computing device 104.]

As another example, the app 114 may be a GPS app which provides turn-by-turn navigation information for the rider. One of the cells designed using the first computing device 102 and displayed on the second computing device 104 may be customized to include static text including “Next Turn,” dynamic text including “0.8 miles” and a dynamic sprite which is a left arrow. The first computing device 102 may communicate this GPS routing data to the second computing device 104 using the API 116. While data from the first buffer page is being displayed, the second frame buffer page is receiving the most current data from the app 114 during a ride such as dynamic text including “0.7 miles.” The most current data in the second frame buffer page is then displayed, and newer current data is used to populate the first frame buffer page to display static text including “Next Turn,” dynamic text including “0.6 miles” and a dynamic sprite, which is still a left arrow visually indicating the upcoming left turn.

As another example, the app 114 may be a speedometer app which provides current speed information for the rider. One of the cells may be customized to include static text including “Speed,” dynamic text of the current speed value such as “20.4 MPH” and a dynamic sprite which includes a compass. The dynamic sprite on the second computing device 104 may be powered by the GPS functionality of the first computing device 102. As an example, if the rider is heading north, the dynamic sprite will be a compass having a needle pointing north. The first computing device 102 may communicate this speed data to the second computing device 104 using the API 116. While this data from the first buffer page is being displayed, the second frame buffer page is receiving the most current data from the app 114 during a ride such as dynamic text including “19.3 MPH” and a dynamic sprite which is a compass having a needle pointing east. The most current data in the second frame buffer page is then displayed, and newer current data is used to populate the first frame buffer page to display static text including “Speed,” dynamic text including “18.7 MPH” and a dynamic sprite which is a compass having a needle pointing northeast.

As another example, the app 114 may be a fitness app for keeping track of lap times. One of the cells displayed on the second computing device 104 may be customized to include static text including “Lap Time,” dynamic text including a current lap time in minutes and seconds, and a sprite including a stopwatch. As noted above, if the rider pushes the “Lap” hardware button, the second computing device 104 will send the “Lap Time” displayed on the display to the first computing device 102 using the API 116 and this lap time will be stored on the first computing device 102.

As another example, the app 114 may be a fitness app which ranks riders on a section of a trail or road. One of the cells displayed on the second computing device 104 may be customized to include static text including “Rank,” dynamic text such as a username of a rider that may be communicated to the app 114 from a server storing ranking information for a section of a trail or road, and a sprite including a mountain. The first computing device 102 may communicate this rank data to the second computing device 104 using the API 116. In this example, the first computing device 104 retrieves information from a remote server or database, and then sends the information to the second computing device 102 for display.

Once a rider completes a section of the trail or the road, or while a rider is in the process of completing the section of the trail or the road, the app 114 will send the rider's time for the section of the trail or the road to the server and the server will determine the rider's rank as compared with all other riders of the section of the trail or road. As an example, the rider may have a time which is in the top 25% of all riders of the section of the trail or road. This ranking information may be sent from the first computing device 102 to the second computing device 104 using the API 116 and displayed temporarily as a modal screen on the second computing device 104 to let the rider know that they have a time which was in the top 25% for the section of the trail or road.

As another example, the app 114 may be a fitness app having audio playback functionality which plays audio stored on the first computing device 102 or plays audio that is streamed from a server to the first computing device 102. One of the cells displayed on the second computing device 104 may include a music note sprite and dynamic text such as a name of a current song being played, a current artist of the current song being played, or a current album of the current song being played. As an example, the cell may display the artist name “Red Hot Chili Peppers” representing the artist of the song currently being played on the first computing device 102. The first computing device 102 may communicate this artist data to the second computing device 104 using the API 116.

As another example, the app 114 may be a fitness app having weather functionality to provide weather information for a current location of the first computing device 102. The fitness app may communicate with a remote server in order to obtain current weather conditions and a user of the app can create a display page for the second computing device 104 to provide current weather conditions or future weather conditions. One of the cells displayed on the second computing device 104 may be customized to include a dynamic sprite based on current weather conditions such as a sun with a cloud partially covering the sun to indicate “partly cloudy,” dynamic text including a current temperature such as “82”, and dynamic text including a current location such as “Washington.” As other examples, a dynamic sprite could include a current weather radar, astatic sprite may include a temperature graph for the current day, and, dynamic text could include a percentage of precipitation. The first computing device 102 may communicate this weather data to the second computing device 104 using the API 116. While the weather data in the first page buffer is being displayed, the second frame buffer page is receiving the most current data from the app. As an example, the rider may be traveling into a new location and the weather may be rapidly changing. The second frame buffer page may be receiving a dynamic sprite of a cloud with a lightning bolt to indicate to the rider that thunderstorms are likely, dynamic text of a dropping current temperature of “75” and a new current location “Arlington.” The most current data in the second frame buffer page is then displayed, and newer current data is used to populate the first frame buffer page.

If the second computing device 104 can read the page buffer and refresh the display 108 quickly, the first computing device 102 may send new data at a rate so that the example cells described above can refresh each second. However, some cells need not be updated every second. As an example, weather information need not be changed as often on a display, and the app 114 need only send new weather data to the second computing device 104 at a less frequent interval. Thus, according to an example embodiment, the app 114 may present display page templates to the user of the app 114, receive input from the user of the app 114 to configure display pages based on the page templates, generate a page definition file including an array of display pages, and communicate an array of configured display pages to the second computing device 104 as the page definition file. As an example, the page definition file may be a comma separated value (CSV) file, an extensible markup language (XML) file, a JavaScript Object Notation (JSON) file, etc. One example of a CSV page definition file including dynamic data for defining a first cell in an array of display pages is provided as follows:

“Page 0”, “Static”, “Cell 1”, “Title_GPS”, “StaticText_Next Turn”, “x=0”, “y=10”, “DynamicText 0.8”, “x=15”, “y=10”, “DynamicSprite_Left Arrow”, “x=5”, “y=15”, “Cell 2” . . .
“Page 1”, “Static”, “Cell 1”, “Title_HR”, “StaticText_Heart Rate”, “x=0”, “y=10”, “DynamicText_{—}142”, x=15″, “y=10”, “StaticSprite_Heart”, “x=5”, “y=15”, “Cell 2” . . .
“Page 2”, “PopUp_{—}5”, “Cell 1”, “Title_Weather”, “DynamicText_Partly Cloudy”, “x=0”, “y=10”, “DynamicText_{—}82”, “x=15”, “y=10”, “DynamicSprite_SunCloud”, “x=5”, “y=15”, “Cell 2” . . .

To display a display page, the second computing device 104 will parse the page definition file and begin to display any static information on the display page. The second computing device 104 will inform the first computing device 102 of the current display page from the array of possible display pages by providing a current page index, such as “Page 0,” to the first computing device 102 using the API 116. The first computing device 102 will receive this current page index and parse the page definition file for the identified page. The first computing device 102 will then transmit all dynamic display data for “Page 0” to the second computing device 104. The dynamic display data may be received by the first computing device 102 and transmitted to the second computing device 104 at a regular interval. For example, the first computing device 102 may transmit . . . “DynamicText_{—}0.8”, “x=15”, “y=10”, “DynamicSprite_Left Arrow”, “x=5”, “y=15”, “ . . . to the second computing device 104. The second computing device 104 will receive this dynamic information into page buffers as described above. The second computing device 104 will initially receive this dynamic data into a first page in the page buffer. Once the first page of the page buffer is full, the display 108 will display all dynamic information for “Page 0.” While the information in the first page of the page buffer is being displayed, the second computing device 104 receives new dynamic data in a second page in the page buffer, and so on.

As a result, the second computing device 104 will display static display data and dynamic display data for a current display page including all static and dynamic text and sprites while the app 114 is running on the first computing device 102.

Page definition files are limited only by the available memory on the second computing device 104. Page definition files may be stored within or as part of a configuration file for an app. More than one configuration file may be used for a single app, such as a first configuration file with a page definition file for running and a second configuration file with a page definition file for cycling within a single app. A user may have display pages customized for running and display pages customized for cycling. Another app that commmunicates with the second computing device 104 may have its own configuration file. Each configuration file may be defined as a JSON file, a CSV file, an XML file, etc. The configuration file is transmitted from the first computing device 102 to the second computing device 104 as a binary optimized version of the configuration file including only data that is relevant to the second computing device 104, such as a page definition file or data related to the page definition files. Thus, data within the configuration file used only by the first computing device 102 to interpret API 116 messages from the second computing device 104 need not be transferred to the second computing device 104.

Whenever a configuration file is modified by an app 114 on a first computing device 102, a unique key is generated. This unique key and the binary optimized configuration file are sent from the app 114 on the first computing device 102 to the second computing device 104 using the API 116. Upon subsequent connections between the first computing device 102 and the second computing device 104, the first computing device 102 will query the second computing device 104 to determine if a binary optimized configuration file and a key that matches the current version are already stored on the second computing device 104. If they do not match, the first computing device 102 will send a copy of the binary optimized configuration file to the second computing device 104 using the API 116.

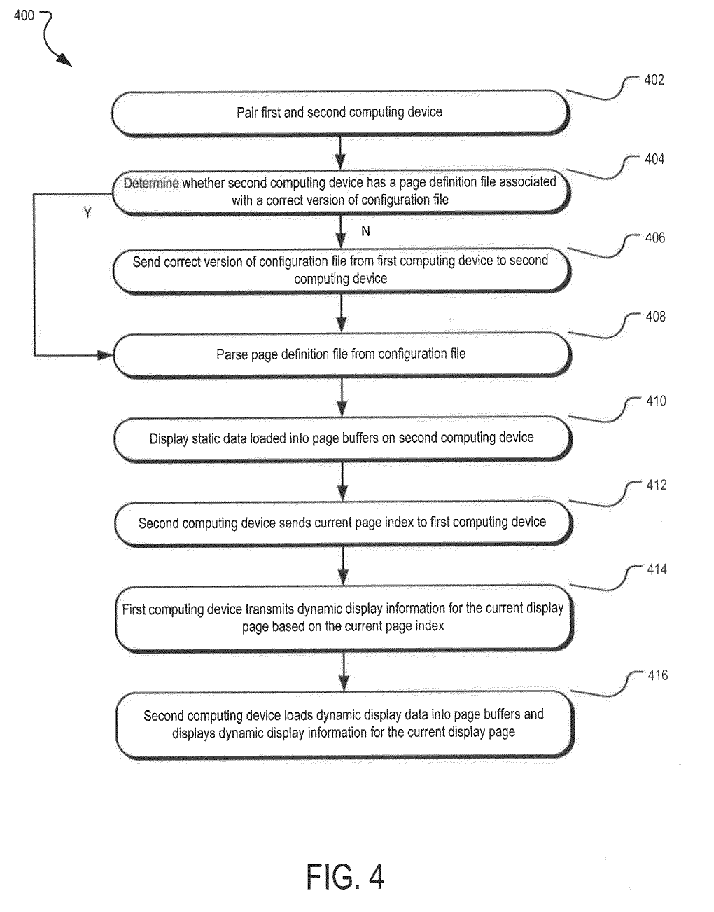

FIG. 4 illustrates a flowchart of a process 400 for displaying ride information according to an example embodiment.

To begin, the first computing device 102 and the second computing device 104 are paired using a wireless protocol (operation 402). For example, using Bluetooth™, when the first computing device 102 is executing the app 114, the second computing device 104 is awake, and they are within a particular proximity of one another, the first computing device 102 and the second computing device 104 will automatically pair with one another.

Next, the first computing device 102 sends a query to the second computing device 104 to determine whether the second computing device 104 has a page definition file associated with the correct version of the configuration file stored in memory (operation 404). If the second computing device 104 does not have a page definition file stored in memory, in step 406 the first computing device 102 and the second computing device 104 will enter file transfer mode and the first computing device 102 will send a copy of the binary optimized version of the configuration file with the page definition file(s) stored within the app 114 to the second computing device 104 using the API 116. If the second computing device 104 does have a page definition file stored in memory, then the first computing device 102 will check to make sure that the copy of the binary optimized version of the configuration file with at least one page definition file stored in the second computing device 104 is a correct version of the binary optimized version of the configuration file. As an example, the binary optimized version of the configuration file with at least one page definition file may include a timestamp or a unique key that is used to determine whether the binary optimized version of the configuration file is a correct or newest version. If the second computing device 104 has an outdated copy of the binary optimized version of the configuration file, the first computing device 102 and the second computing device 104 will enter file transfer mode and the first computing device 102 will transmit the a binary optimized version of the correct version of the configuration file to the second computing device 104 using the API 116.

If the second computing device 104 does have a binary optimized version configuration file and it is the correct version of the configuration file, the second computing device 104 will load page definition file(s) within the configuration file into memory and parse the page definition file(s) (operation 408). Once the page definition file is loaded into memory, the second computing device 104 parses the page definition file to determine what information is to be displayed on a display page and where the information should be laid out on the display 108. Stated another way, the second computing device 104 parses the page definition file to determine where each instance of static text, dynamic text, static sprites, and dynamic sprites are to be displayed a display page on the display 108. The page definition file also includes information such as font size, font color, text size, and sprite size as well as any border information for display pages, and the second computing device 104 uses this information to stylize the display page.

The second computing device 104 will then display a page based on data parsed from the page definition file by first displaying the static display information on the page. To display the information on the page, the display page information is loaded into display page buffers. The static information will be loaded into each of the display page buffers and this static information will not be reloaded until the display page is changed. However, the dynamic information will not yet be displayed. Thus, the display page may appear “blank” while the second computing device 104 is in the process of retrieving the dynamic information. This display of only static information may occur for a moment when a display page is first displayed.

The second computing device 104 will need to populate dynamic display data for the current display page. In order to receive this dynamic display data, the second computing device 104 will notify the first computing device 102 a current display page being displayed by sending a current page index to the first display device 102 (operation 412). The second computing device 104 notifies the first computing device 102 of the current display page index by using an API call. The first display device 102 will use the page definition file in the configuration file to determine what dynamic information is needed for the current display page being displayed on the second display device 104 and package the dynamic information to be sent to the second computing device.

In step 414, the first display device 102 will send the dynamic display information for the current display page as well as a previous display page and a next display page, if applicable. All dynamic information is sent from the first computing device 102 to the second computing device 104 using an API call.

In step 416, the second computing device 104 will load the received dynamic information into the display buffers and display a complete display page on the display 108 including static display information and dynamic display information. New dynamic display page information will be continually received by the second computing device 104 and buffered. Thus, while the second computing device 104 is displaying information from a first page buffer, the new dynamic display page information will be stored in a second page buffer which already has the static information loaded. The second computing device 104 will transition to display the information from the second page buffer, and new dynamic display page information will be stored in the unused first page buffer, on so on.

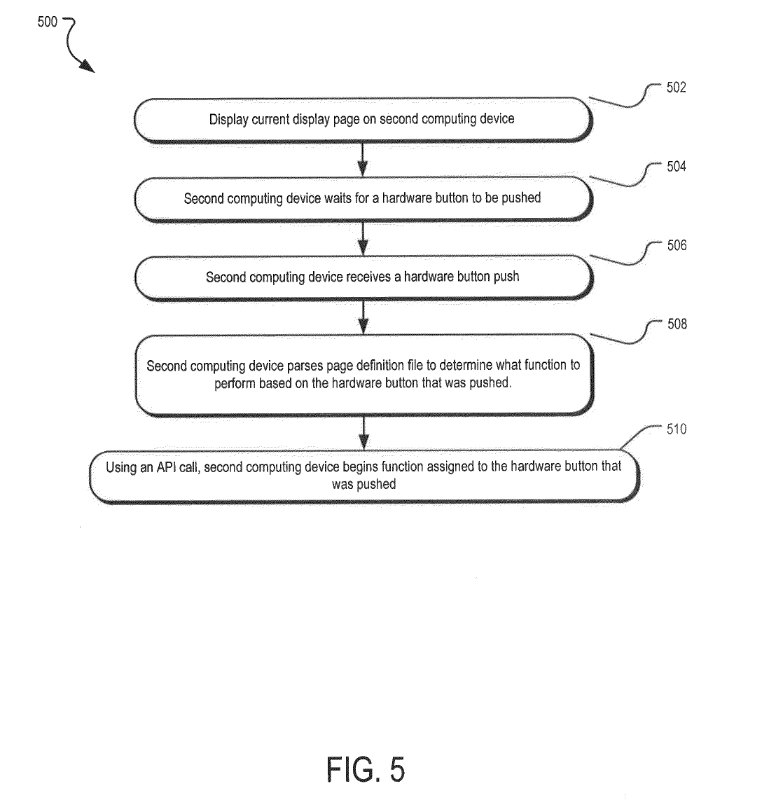

FIG. 5 illustrates a flowchart of a process 500 for receiving a hardware button push on the second computing device 104 and performing a corresponding function. As an example, the hardware button push may cause the display page to be changed to a different display page.

In step 502, the second display device 104 may be displaying static display information and dynamic display information on a first display page as in step 416 described above.

In step 504, the second display device 104 will continue to display the first display page and will wait for a hardware button 106 to be pushed. In step 506, the second display device 104 will receive a button push for one of the hardware buttons 106. The second display device 104 will determine which hardware button was pushed and, if applicable, how many times the hardware button was pushed and/or how long the hardware button was pushed.

In step 508, after the hardware button push, the second display device 104 parses the page definition file to determine what function to perform based on the hardware button 106 that was pushed.

In step 510, the second computing device 104 will perform the function that is assigned to the hardware button that was pushed. To perform the function, the second computing device 104 may execute an API call. According to an exemplary embodiment, the API 116 sends a delegate response that a button action occurred and information regarding what button was pressed. The app 114 on the first computing device 102 receives the button action from the second computing device 104 and responds appropriately based on the button press.

As a specific example, the second computing device 104 may transition to a next display page in the array of display pages or a last display page in the array of display pages by changing a current page index. Using an API call, the second computing device 104 will inform the first computing device 102 that the current page index has changed and the first computing device 102 will begin to send dynamic data to the second computing device 104 corresponding to a new set of display pages based on the current page index. As another specific example, using an API call, the second computing device 104 may send a message to the first computing device 102 and cause the first computing device 102 to skip to a next song on a music playlist and begin playing the next song.

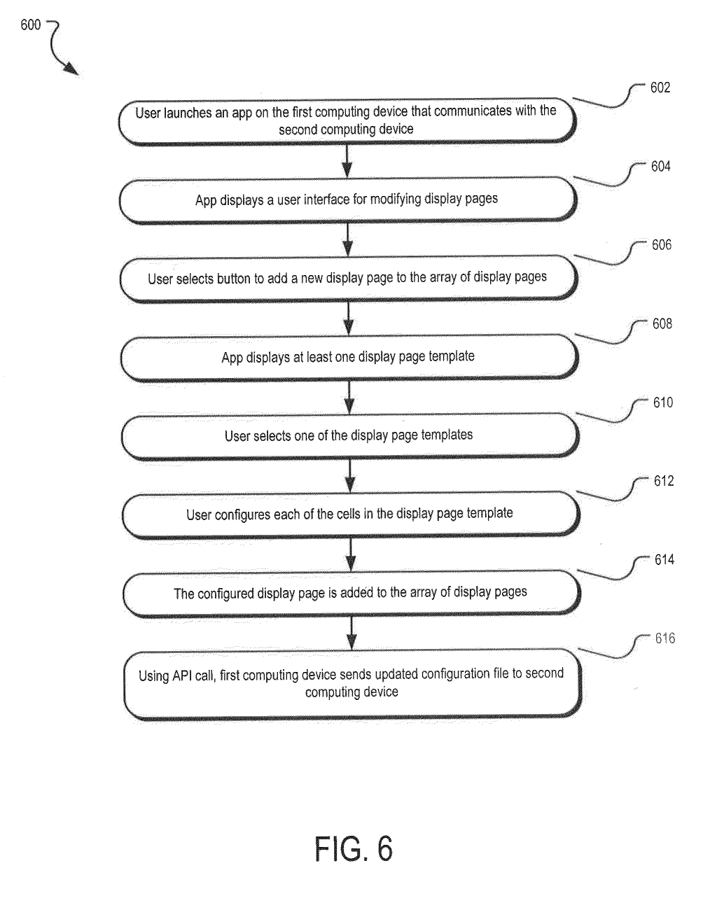

FIG. 6 illustrates a flowchart of a process for designing/customizing a display page using the first computing device 102 according to an example embodiment. Once a display page is designed using the first computing device 102, it is added to the array of display pages in the page definition file. The page definition file will then be sent in binary optimized version of a configuration file from the first computing device 102 to the second computing device 104 using an API call.

In step 602, the user may open an app 114 on the first computing device 102 that communicates with the second computing device 104 using the API 116. The first computing device 102 and the second computing device 104 will automatically pair with one another as described above.

Once the devices are paired and the app 114 is opened on the first computing device 102, the app 114 may display a user interface (operation 604). This user interface may include at least one tab, wherein each tab provides a subset of the user interface. A first tab may provide a user interface for viewing/editing the display page array. The user may edit the current display pages in the array, add new display pages to the array, or delete display pages from the array. The user interface may display a representation of the current array of display pages, and the user of the app 114 may scroll through the current array of display pages. The user may rearrange the order of the display pages, edit the configured display pages, and delete any of already created display pages.

In step 606, the user may select a button in the user interface of the app 114 to allow the user to add a new display page to the array of display pages. As an example, this button may be a “+” sign to signify to the user that when depressed, the app 114 will begin a process to design and add a new display page to the array of display pages.

In step 608, the app 114 may display at least one display page template and/or predesigned display pages created by the app programmer. A predesigned display page is shown in FIG. 3A and a display page template is shown in FIG. 3B. These easily allow a user of the first computing device 102 to add a new display page to their array of display pages.

In step 610, the user may select one of the at least one display page templates by selecting a page template using the user interface of the app 114. The display page template may include at least one cell. Once selected, the app 114 may then display a “blank” version of the display page template which indicates that each of the cells in the display page template is ready to be configured. As an example, each cell may initially be unassigned and display a static sprite which is a question mark—“?” as shown in FIG. 3B.

In step 612, the user may configure each of the cells in the display page template displayed by the user interface of the app 114 by first selecting the cell and then selecting from display page options which are presented in the app 114 as shown in FIGS. 3C-3E. These display page options are discussed above.

After the display page is fully configured by the user, in step 614, the first computing device 102 adds the newly configured display page to the array of display pages in the page definition file. In step 616, the system will enter file transfer mode and the first computing device 102 will send the page definition file in a binary optimized version of the configuration file for the app 114 to the second computing device 104 using an API call.

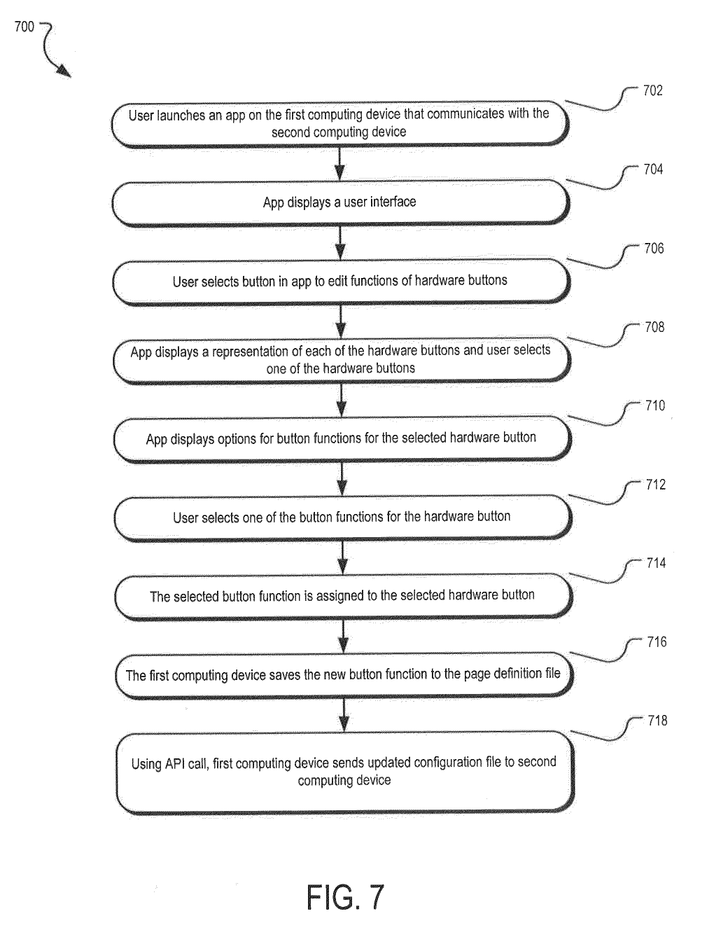

FIG. 7 illustrates a flowchart of a process for designing button functions for the hardware buttons 106 of the second computing device 104 according to an example embodiment. Once a button function is assigned using the first computing device 102, it is saved in the page definition file and the updated page definition file is sent to the second computing device 104 in a binary optimized version of the configuration file using an API call.

In step 702, the user may open an app 114 on the first computing device 102 for communicating with the second computing device 104. The first computing device 102 and the second computing device 104 will automatically pair with one another as described above.

Once the devices are paired and the app 114 is opened on the first computing device 102, the app 114 may display a user interface (operation 704). The user interface may include a tab for editing hardware button functionality as shown in FIG. 3F.

In step 706, the user may select a button in the user interface of the app 114 to edit the functions of the plurality of hardware buttons 106. As an example, the user interface presented in the app 114 on the first computing device 102 may display a grid with four selectable buttons, each representing one of the hardware buttons on the second computing device 104. This is shown in FIG. 3F. As shown in FIG. 3F, the hardware buttons currently are assigned functions which are “Lap,” “Start/Pause/Resume Workout,” “Previous Page,” and “Next Track.” In addition, as another specific example, the user interface presented in the app 114 on the first computing device 102 may display a grid with eight selectable buttons, each representing one of the hardware buttons and a single press or double press of one of the hardware buttons on the second computing device.

In step 708, the user may select a representation of one of the hardware buttons 106 that is shown within the app 114 on the first computing device 102. As a specific example, the user may want to make the bottom left hardware button the button to push to cycle to a next display page in the array of display pages and change the current function of “Previous Page.”

In step 710, after selecting the representation of the hardware button, the app 114 may display options for possible button functions for the selected hardware button and number of button presses. The app 114 may display a list of options as shown in FIG. 3G including “None,” “Previous Page,” “Next Page,” “Start/Pause/Resume Workout,” “Lap,” “Backlight On/Off,” and “Music.”

In step 712, the user may select one of the button functions for the selected hardware button, such as “Next Page.” In step 714, the selected button function “Next Page” is assigned to the selected hardware button. In step 716, the first computing device 102 may save the new button function, “Next Page,” for the bottom left hardware button to the page definition file. In step 718, the first computing device 102 and the second computing device 104 will enter file transfer mode and the first computing device 102 will send the updated page definition file in a binary optimized version of the configuration file to the second computing device 104 using an API call.

### Example Display Pages

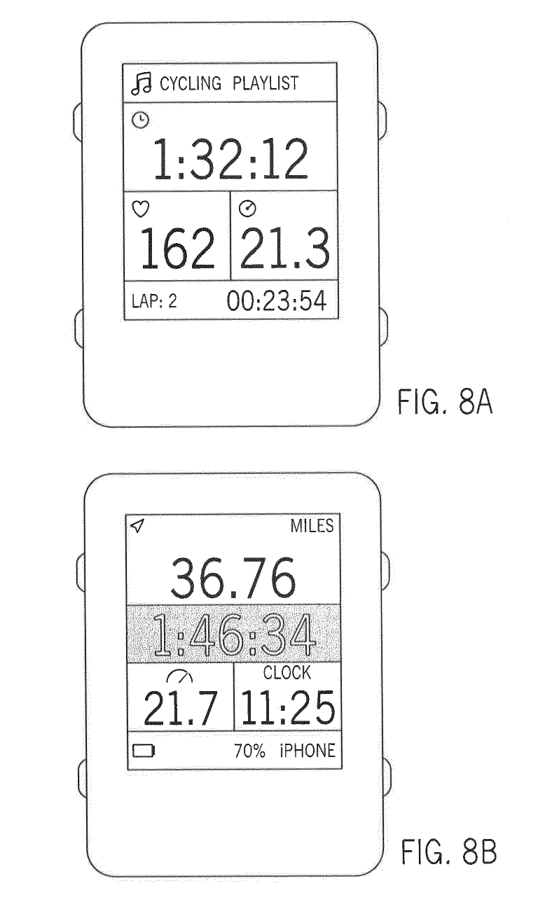

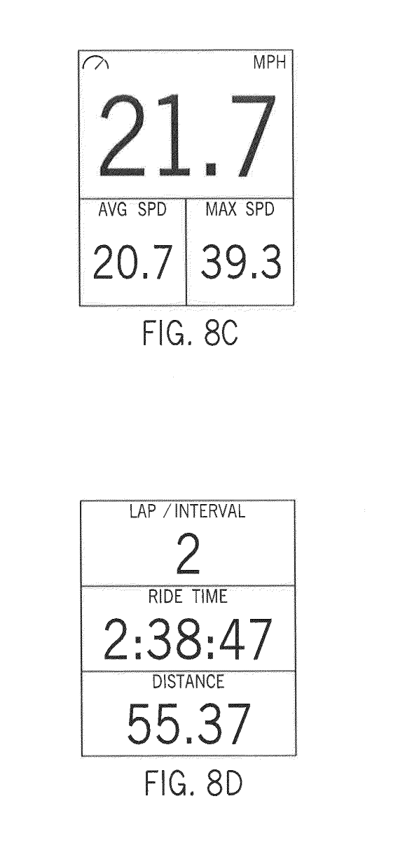

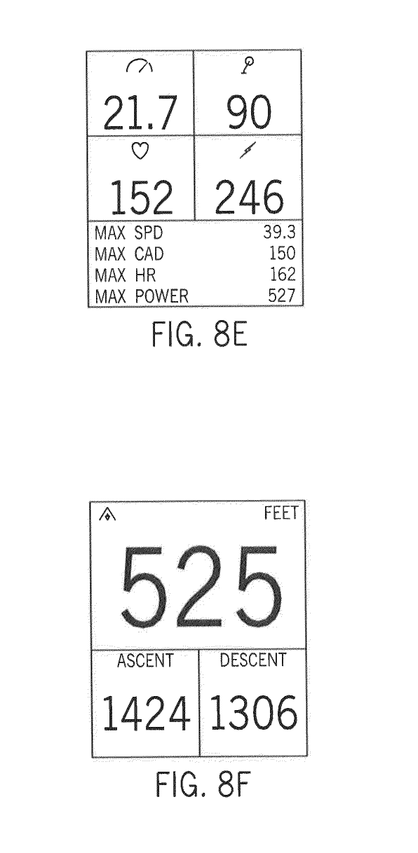

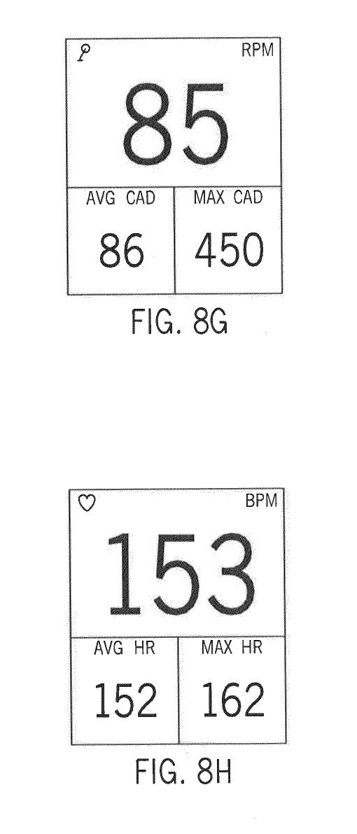

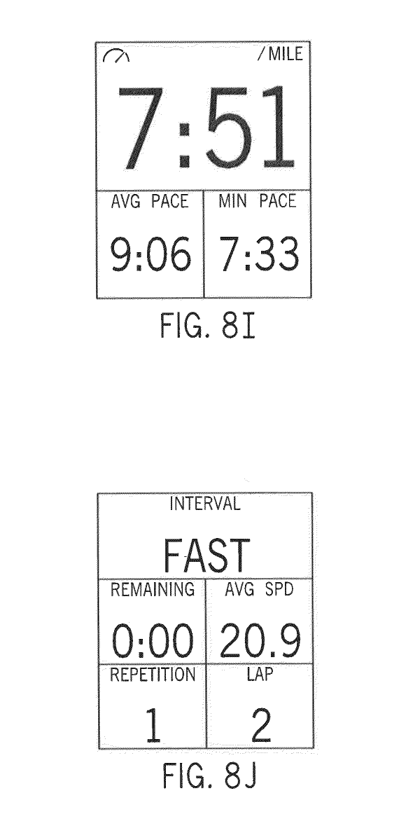

FIGS. 8A-8J illustrate example screenshots showing display pages on the display 108 on the second computing device 104.

FIG. 8A shows five different data cells. The first data cell on the top is a music-based cell and includes a music note static sprite and dynamic text which represents a name of a current music playlist, “Cycling Playlist.” FIG. 8A also includes a total ride time cell that includes a static sprite that is a stopwatch and dynamic text that is currently “1:32:12,” a current heart rate cell that includes a static sprite that is a heart and dynamic text that is “162,” a speed cell that includes a static sprite that is a speedometer and dynamic text which is “21.3,” and a lap cell that includes dynamic text of “Lap: 2” and dynamic text of “00:23:54.”

FIG. 8B shows five different data cells. The first data cell on the top is a mileage data cell and includes a static sprite of a compass needle. The first data cell also includes static text of “miles” and dynamic text that is currently “36.76.” The second data cell includes a total ride time including dynamic text that is currently “1:46:34.” To differentiate this second data cell from other data cells, the programmer of the app has set the second data cell to have a dark background and white text. A third data cell is a speed cell including a static sprite that is a speedometer and dynamic text of currently “21.7.” A fourth data cell is a time data cell. This fourth data cell includes static text that is “Clock” and dynamic text representing the current time of “11:25.” A fifth data cell includes battery information for the first computing device 104. This fifth data cell includes a static or dynamic sprite that is a battery, dynamic text representing the name of the first computing device 104 “iPhone” and dynamic text including a current battery life percentage of “70%.”

FIG. 8C shows three different data cells. The first data cell on the top is a larger data cell having a larger font size than the other example screenshots previously discussed. This first data cell is a current speed data cell including a static sprite of a speedometer, static text of “mph” and dynamic text of “21.7.” A second data cell is an average speed data cell. This second data cell includes static text of “Avg Spd” and dynamic text of “20.7.” A third data cell is a maximum speed data cell. This third cell includes static text of “Max Spd” and dynamic text of “39.3.”

FIG. 8D illustrates three different data cells each having an equal, rectangular shape. The first data cell on the top is a lap data cell and includes static text of “Lap/Interval” and dynamic text of “2.” The second data cell in the middle is a ride time data cell and includes static text of “Ride Time” and dynamic text of “2:38:47.” The third data cell on the bottom is a distance data cell and includes static text of “Distance” and dynamic text of “55.37.”

FIG. 8E illustrates a display page with a plurality of data cells. A first data cell in the top left corner is a current speed data cell and includes a static sprite of a speedometer and dynamic text of “21.7.” A second data cell in the top right corner is a cadence data cell and includes a static sprite of a pedal and dynamic text of “90.” A third data cell in the middle left is a heart rate data cell and includes a static sprite that is a heart and dynamic text that is “152.” A fourth data cell in the middle right is a current power data cell and includes a static sprite of a lightning bolt and dynamic text of “246.” A fifth data cell includes static text of “Max Spd” and associated dynamic text of “39.3” The fifth cell also includes static text of “Max Cad” and associated dynamic text of “150,” static text of “Max HR” and associated dynamic text of “162,” and static text of “Max Power” and dynamic text of “527.”

FIG. 8F illustrates three different data cells that provide altitude related information. This altitude information may be obtained from the altimeter in the second computing device 104 and/or the first computing device 102. A first data cell on the top is a current altitude data cell that includes a static sprite of a mountain, static text of “feet” and dynamic text of “525.” A second data cell on the bottom left is a total ascent data cell that includes static text of “Ascent” and dynamic text of “1424.” A third data cell on the bottom right is a total descent data cell that includes static text of “Descent” and dynamic text of “1306.”

FIG. 8G illustrates three different data cells that provide cadence related information. A first data cell on the top is a current cadence data cell that includes a static sprite of a pedal, static text of “rpm”, and dynamic text of “85.” A second data cell on the bottom left is an average cadence data cell that includes static text of “Avg Cad” and dynamic text of “86.” A third data cell on the bottom right is a maximum cadence data cell that includes static text of “Max Cad” and dynamic text of “150.”

FIG. 8H illustrates three different data cells that provide heart rate information. A first data cell on the top is a current heart rate data cell that includes a static sprite of a heart, static text of “bpm”, and dynamic text of “153.” A second data cell on the bottom left is an average heart rate data cell that includes static text of “Avg HR” and dynamic text of “152.” A third data cell on the bottom right is a maximum heart rate data cell that includes static text of “Max HR” and dynamic text of “162.”

FIG. 8I illustrates three different data cells that provide pace information. A first data cell on the top is a current pace data cell that includes a static sprite of a speedometer, static text of “/mile”, and dynamic text of “7:51.” A second data cell on the bottom left is an average pace data cell that includes static text of “Avg Pace” and dynamic text of “9:06.” A third data cell on the bottom right is a minimum pace data cell that includes static text of “Min Pace” and dynamic text of “7:33.”

FIG. 8J illustrates five different data cells that provide interval training information. A first data cell on the top includes static text of “Interval” and dynamic text of “Fast.” A second data cell on the middle left includes static text of “Remaining” and dynamic text of “0:00.” A third data cell on the middle right includes static text of “Avg Spd” and dynamic text of “20.9.” A fourth data cell on the bottom left includes static text of “Repetition” and dynamic text of “1.” A fifth data cell on the bottom right includes static text of “Lap” and dynamic text of “2.”

FIGS. 8A-8J are example display pages that may be selected and customized by a user of an app being executed on the first computing device 102 according to an example embodiment. As shown by the variety of fitness related information displayed in the display pages, a user may configure a display page with a myriad of available of information provided by an app on the first computing device 102.

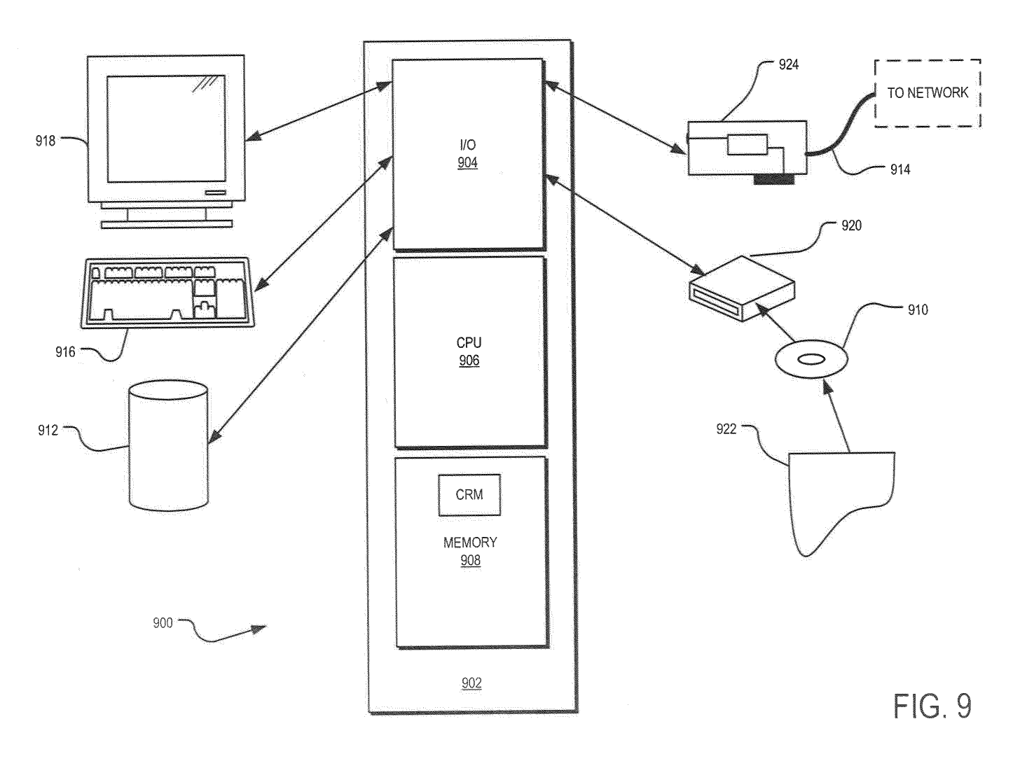

FIG. 9 illustrates an example computing system 900 that may implement various systems and methods discussed herein. A general purpose computer system 900 is capable of executing a computer program product to execute a computer process. Data and program files may be input to the computer system 900, which reads the files and executes the programs therein. Some of the elements of a general purpose computer system 900 are shown in FIG. 9 wherein a processor 902 is shown having an input/output (I/O) section 904, a Central Processing Unit (CPU) 906, and a memory section 908. There may be one or more processors 902, such that the processor 902 of the computer system 900 comprises a single central-processing unit 906, or a plurality of processing units, commonly referred to as a parallel processing environment. The computer system 900 may be a conventional computer, a distributed computer, or any other type of computer, such as one or more external computers made available via a cloud computing architecture. The presently described technology is optionally implemented in software devices loaded in memory 908, stored on a configured DVD/CD-ROM 910 or storage unit 912, and/or communicated via a wired or wireless network link 914, thereby transforming the computer system 900 in FIG. 9 to a special purpose machine for implementing the described operations.

The I/O section 904 is connected to one or more user-interface devices (e.g., a keyboard 916 and a display unit 918), a disc storage unit 912, and a disc drive unit 920. Generally, the disc drive unit 920 is a DVD/CD-ROM drive unit capable of reading the DVD/CD-ROM medium 910, which typically contains programs and data 922. Computer program products containing mechanisms to effectuate the systems and methods in accordance with the presently described technology may reside in the memory section 904, on a disc storage unit 912, on the DVD/CD-ROM medium 910 of the computer system 900, or on external storage devices made available via a cloud computing architecture with such computer program products, including one or more database management products, web server products, application server products, and/or other additional software components. Alternatively, a disc drive unit 920 may be replaced or supplemented by a floppy drive unit, a tape drive unit, or other storage medium drive unit. The network adapter 924 is capable of connecting the computer system 900 to a network via the network link 914, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 900 is connected (by wired connection or wirelessly) to a local network through the network interface or adapter 924, which is one type of communications device. When used in a WAN-networking environment, the computer system 900 typically includes a modem, a network adapter, or any other type of communications device for establishing communications over the wide area network. In a networked environment, program modules depicted relative to the computer system 900 or portions thereof, may be stored in a remote memory storage device. It is appreciated that the network connections shown are examples of communications devices for and other means of establishing a communications link between the computers may be used.

In an example implementation, the framework or API 116 bundled within an app 114 executing on the computing device 102 wirelessly communicating with the second computing device 104, a plurality of internal and external databases, source databases, and/or cached data on servers are stored as the memory 908 or other storage systems, such as the disk storage unit 912 or the DVD/CD-ROM medium 910, and/or other external storage devices made available and accessible via a network architecture. The framework or API 116 bundled within an app 114 may be embodied by instructions stored on such storage systems and executed by the processor 902.

Some or all of the operations described herein may be performed by the processor 902. Further, local computing systems, remote data sources and/or services, and other associated logic represent firmware, hardware, and/or software configured to control operations of the bicycle computer system 100 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 902 and a user may interact with a Graphical User Interface (GUI) using one or more user-interface devices (e.g., the keyboard 916, the display unit 918, and the user devices 904) with some of the data in use directly coming from online sources and data stores. The system set forth in FIG. 9 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method, comprising:
wirelessly pairing a first computing device having a first processor and a first display with a second computing device having a second processor and a second display;
parsing a page definition file received from the first computing device to determine static display data for a current display page index;
displaying the static display data and transmitting the current display page index to the first computing device using an application programming interface (API);
receiving dynamic display data associated with the current display page index from the first computing device using the API; and
displaying the dynamic display data for the current display page index.

2. The method of claim 1, wherein the page definition file is one of a JavaScript Object Notation (JSON) file, a comma separated value (CSV) file, and an extensible markup language (XML) file.

3. The method of claim 1, further comprising:
receiving an update of the page definition file from the first computing device using the API.

4. The method of claim 1, wherein the dynamic display data comprises at least one of first computing device battery life information, mileage information, speed information, cadence information, music information, power information, altitude information, location information, and heart rate information.

5. The method of claim 1, further comprising:
transmitting an update of the current page index to the first computing device using the API.

6. The method of claim 1, further comprising:
configuring at least one display page defined in the page definition file, the configuring comprising:
receiving a selection of a display page template having at least one configurable cell;
creating a new display page based on the display page template;
receiving an assignment of at least one data value to the at least one configurable cell in the new display page, the at least one data value based on data collected by the first computing device including static text, dynamic text, a static sprite, and a dynamic sprite, and comprises one of workout state information, lap count information, time information, distance information, pace information, speed information, splits information, cadence information, and calories information; and
saving the new display page in an array of display pages represented in the page definition file, each display page in the array of display pages having a display page index.

7. The method of claim 1, further comprising:
configuring a hardware button, the configuring comprising:
receiving a selection of a representation of the hardware button;
receiving a selection of a function to be performed by the hardware button;
assigning the function to the hardware button; and
saving the function to be performed by the hardware button to the page definition file.

8. The method of claim 1, further comprising:
configuring a hardware button, the configuring comprising:
receiving a selection of a representation of the hardware button;
selecting a number of presses of the hardware button;
receiving a selection of a function to be performed by the number of presses of the hardware button;
assigning the function to the number of presses of the hardware button; and
saving the function to be performed by the number of presses of the hardware button to the page definition file.

9. The method of claim 1, further comprising:
configuring a hardware button, the configuring comprising:
receiving a selection of a representation of the hardware button;
receiving a selection of a button press length of the hardware button;
receiving a selection of a function to be performed by the button press length of the hardware button;
assigning the function to the button press length of the hardware button; and
saving the function to be performed by the button press length of the hardware button to the page definition file.

10. The method of claim 7, further comprising:
configuring the hardware button to be a trigger button which when pressed causes a modal display to be displayed.

11. The method of claim 7, further comprising:
receiving a hardware button push;
parsing the page definition file to identify a function to be performed by the hardware button push;
transmitting a message with the function to the first computing device using the API; and
performing the function.

12. The method of claim 11, wherein the function comprises one of changing the current display page index, temporarily displaying a trigger display page, turning on a backlight of the second computing device, turning off a backlight of the second computing device, and performing a music function on the first computing device.

13. The method of claim 1, further comprising:
storing the static display data and the dynamic display data for the current display page index in a first buffer;
receiving new dynamic display data using the API and storing the static display data and the new dynamic display data in a second buffer; and
displaying the new dynamic display data.

14. A device, comprising:
a display; and
at least one processor in operable communication with the display, the at least one processor in communication with a memory, the at least one processor configured to:
wirelessly pair the device;
wirelessly receive a page definition file using an application programming interface (API);
display static display data responsive to a current display page index and transmit the current display page index using the API;
receive dynamic display data associated with the current display page index using the API; and
display dynamic display data.

15. The device of claim 14, wherein the display comprises a chip-on-glass liquid crystal display.

16. The device of claim 14, wherein the display comprises a 128×128 pixel chip-on-glass liquid crystal display.

17. The device of claim 14, further comprising a short range wireless network transceiver.

18. The device of claim 17, wherein the short range wireless network transceiver comprises a Bluetooth transceiver.

19. The device of claim 17, wherein the short range wireless network transceiver comprises an ANT+ transceiver.

20. The device of claim 14, further comprising a coin cell battery.

21. The device of claim 14, further comprising a housing for the device having at least one hardware button that when pressed performs at least one of transmitting a message using the API, performing no function, changing the current display page index, changing a current display page to a previous display page, changing a current display page to a next page, starting a workout, pausing a workout, resuming a workout, starting a new lap, turning a backlight on, turning a backlight off, beginning music playback, pausing music playback, changing a current music track to a next track, and changing a current music track to a previous track.

22. The device of claim 14, further comprising a housing for the device having four hardware buttons, wherein when depressed each button is operable to perform at least one of transmitting a message using the API, performing no function, changing the current display page index, changing a current display page to a previous display page, changing a current display page to a next page, starting a workout, pausing a workout, resuming a workout, starting a new lap, turning a backlight on, turning a backlight off, beginning music playback, pausing music playback, changing a current music track to a next track, and changing a current music track to a previous track.

23. The device of claim 22, wherein the four hardware buttons comprise a first hardware button located on a top left of the housing, a second hardware button located on a top right of the housing, a third hardware button located on a bottom left of the housing, and a fourth hardware button located on a bottom right of the housing.

24. A device, comprising:
a touch screen display; and
at least one processor in operable communication with the touch screen display, the at least one processor in communication with a memory, the at least one processor configured to:
wirelessly pair the device;
transmit a page definition file using an application programming interface (API);
receive a current display page index using the API; and
transmit dynamic display data determined by the device based on the page definition file and the current display page index using the API.

25. The device of claim 24, the at least one processor further configured to:
customize at least one display page defined in the page definition file.

26. The device of claim 24, the at least one processor further configured to:
display at least one display page template having at least one configurable cell;
receive a selection of a display page template having at least one configurable cell;
create a new display page based on the selected display page template;
receive a selection of at least one data value and assign the at least one data value to the at least one configurable cell in the new display page, the at least one data value based on data collected by the device including static text, dynamic text, a static sprite, and a dynamic sprite; and
save the new display page in an array of display pages represented in the page definition file, each display page in the array of display pages having a display page index.

27. The device of claim 26, wherein the at least one data value is based on one of workout state information, lap count information, time information, distance information, pace information, speed information, splits information, cadence information, and calories information.

28. The device of claim 24, the at least one processor further configured to:
customize a hardware button to perform a function, the function comprising one of transmitting a message using the API, changing the current display page index, performing no function, changing a current display page to a previous display page, changing a current display page to a next page, adding one to the current display page index, starting a workout, pausing a workout, resuming a workout, starting a new lap, turning a backlight on, turning a backlight off, beginning music playback, pausing music playback, changing a current music track to a next track, and changing a current music track to a previous track.

29. The device of claim 28, the at least one processor further configured to:
display a representation of the hardware button.
receive a selection of the representation of the hardware button;
display at least one possible function to be performed by the hardware button;
receive a selection of a function of the at least one possible function to be performed by the hardware button; and
save the function of the at least one possible function to be performed by the hardware button to the page definition file.

30. The device of claim 24, the at least one processor further configured to:
transmit an update of the page definition file using the API.

31. The device of claim 24, wherein the dynamic display data comprises at least one of device battery life, mileage information, speed information, cadence information, music information, power information, altitude information, location information, and heart rate information.

32. The device of claim 24, the at least one processor further configured to:
receive an update of the current page index using the API.

33. A fitness device, comprising:
a first computing device having a first processor and a first display wirelessly paired with a second computing device having a second processor and a second display, the fitness device configured to:
parse a page definition file received from the first computing device to determine static display data for a current display page index;
display the static display data and transmit the current display page index to the first computing device using an application programming interface (API);
receive dynamic display data associated with the current display page index from the first computing device using the API; and
display the dynamic display data for the current display page index.

34. The fitness device of claim 33, wherein the page definition file is one of a JavaScript Object Notation (JSON) file, a comma separated value (CSV) file, and an extensible markup language (XML) file.

35. The fitness device of claim 33, further configured to:
receive an update of the page definition file from the first computing device using the API.

36. The fitness device of claim 33, wherein the dynamic display data comprises at least one of first computing device battery life information, mileage information, speed information, cadence information, music information, power information, altitude information, location information, and heart rate information.

37. The fitness device of claim 33, further configured to:
transmit an update of the current page index to the first computing device using the API.

38. The fitness device of claim 33, further configured to:
configure at least one display page defined in the page definition file;
receive a selection of a display page template having at least one configurable cell;
create a new display page based on the selected display page template;
receive an assignment of at least one data value to the at least one configurable cell in the new display page, the at least one data value based on data collected by the first computing device including static text, dynamic text, a static sprite, and a dynamic sprite; and
save the new display page in an array of display pages represented in the page definition file, each display page in the array of display pages having a display page index.

39. The fitness device of claim 33, further configured to:
customize a hardware button function, comprising:
receive a selection of a representation of a hardware button;
receive a selection of a function to be performed by the hardware button;
assign the function to the hardware button; and
save the function to be performed by the hardware button to the page definition file.

40. The fitness device of claim 33, further configured to:
customize a hardware button function, comprising:
receive a selection of a representation of a hardware button;
receive a selection of a number of presses of the hardware button;
receive a selection of a function to be performed by the number of presses of the hardware button;
assign the function to the number of presses of the hardware button; and
save the function to be performed by the number of presses of the hardware button to the page definition file.

41. The fitness device of claim 33, further configured to:
customize a hardware button function, comprising:
receive a selection of a representation of a hardware button;
receive a selection of a button press length of the hardware button;
receive a selection of a function to be performed by the button press length of the hardware button;
assign the function to the button press length of the hardware button; and
save the function to be performed by the button press length of the hardware button to the page definition file.

42. The fitness device of claim 39, further configured to:
customize the hardware button to be a trigger button which when pressed causes a modal display to be displayed.

43. The fitness device of claim 39, further configured to:
receive a hardware button push;
parse the page definition file to identify a function to be performed by the hardware button push;
transmit a message with the function to the first computing device using the API; and
perform the function.

44. The fitness device of claim 43, wherein the function comprises one of changing the current display page index, temporarily displaying a trigger display page, turning on a backlight of the second computing device, turning off a backlight of the second computing device, and performing a music function on the first computing device.

45. The fitness device of claim 33, further configured to:
store the static display data and the dynamic display data for the current display page index in a first buffer;
receive new dynamic display data using the API and store the static display data and the new dynamic display data in a second buffer; and
display the new dynamic display data.

46. A non-transitory computer-readable medium having instructions stored thereon that, when executed by at least one computing device, cause the at least one computing device to perform operations comprising:
wirelessly pairing a first computing device having a first processor and a first display with a second computing device having a second processor and a second display;
parsing a page definition file received by the first computing device to determine static display data for a current display page index;
displaying the static display data and transmitting the current display page index to the first computing device using an application programming interface (API);
receiving dynamic display data associated with the current display page index from the first computing device using the API; and
displaying the dynamic display data for the current display page index.

47. The non-transitory computer-readable medium of claim 46, wherein the page definition file is one of a JavaScript Object Notation (JSON) file, a comma separated value (CSV) file, and an extensible markup language (XML) file.

48. The non-transitory computer-readable medium of claim 46, the operations further comprising:
receiving an update of the page definition file from the first computing device using the API.

49. The non-transitory computer-readable medium of claim 46, wherein the dynamic display data comprises at least one of first computing device battery life information, mileage information, speed information, cadence information, music information, power information, altitude information, location information, and heart rate information.

50. The non-transitory computer-readable medium of claim 46, the operations further comprising:
transmitting an update of the current page index to the first computing device using the API.

51. The non-transitory computer-readable medium of claim 46, the operations further comprising:
configuring at least one display page defined in the page definition file, the configuring comprising:
receiving a selection of a display page template having at least one configurable cell;
creating a new display page based on the display page template;
assigning at least one data value to the at least one configurable cell in the new display page, the at least one data value based on data collected by the first computing device including static text, dynamic text, a static sprite, and a dynamic sprite; and
saving the new display page in an array of display pages represented in the page definition file, each display page in the array of display pages having a display page index.

52. The non-transitory computer-readable medium of claim 46, the operations further comprising:
configuring a hardware button, the configuring comprising:
receiving a selection of a representation of the hardware button;
receiving a selection of a function to be performed by the hardware button;
assigning the function to the hardware button; and
saving the function to be performed by the hardware button to the page definition file.

53. The non-transitory computer-readable medium of claim 46, the operations further comprising:
configuring a hardware button, the configuring comprising:
receiving a selection of a representation of the hardware button;
receiving a selection of a number of presses of the hardware button;
receiving a selection of a function to be performed by the number of presses of the hardware button;
assigning the function to the number of presses of the hardware button; and
saving the function to be performed by the number of presses of the hardware button to the page definition file.

54. The non-transitory computer-readable medium of claim 46, the operations further comprising:
configuring a hardware button, the configuring comprising:
receiving a selection of a representation of the hardware button;
receiving a selection of a button press length of the hardware button;
receiving a selection of a function to be performed by the button press length of the hardware button;
assigning the function to the button press length of the hardware button; and
saving the function to be performed by the button press length of the hardware button to the page definition file.

55. The non-transitory computer-readable medium of claim 52, the operations further comprising:
configuring the hardware button to be a trigger button which when pressed causes modal display to be displayed.

56. The non-transitory computer-readable medium of claim 52, the operations further comprising:
receiving a hardware button push;
parsing the page definition file to identify a function to be performed by the hardware button push;
transmitting a message with the function to the first computing device using the API; and
performing the function.

57. The non-transitory computer-readable medium of claim 56, wherein the function comprises one of changing the current display page index, temporarily displaying a trigger display page, turning on a backlight of the second computing device, turning off a backlight of the second computing device, and performing a music function on the first computing device.

58. The non-transitory computer-readable medium of claim 46, the operations further comprising:
storing the static display data and the dynamic display data for the current display page index in a first buffer;
receiving new dynamic display data using the API and storing the static display data and the new dynamic display data in a second buffer; and
displaying the new dynamic display data.
